(19) United States
(12) Patent Application Publication
(10) Pub. No.: US 2026/0081139 A1
(43) Pub. Date: Mar. 19, 2026

(54) COMPOSITE MATERIAL FOR CATHODE ACTIVE MATERIAL AND ITS MANUFACTURING METHOD

(71) Applicants: Research & Business Foundation SUNGKYUNKWAN UNIVERSITY, Suwon-si (KR); University-Industry Cooperation Group of Kyung Hee University, Yongin-si (KR)

(72) Inventors: Won-Sub Yoon, Seoul (KR); Wontae LEE, Suwon-si (KR); Seongeun LEE, Suwon-si (KR); Min-Sik PARK, Suwon-si (KR); Hyo Bin LEE, Goheung-gun (KR); Sungmin PARK, Hanam-si (KR); Yun Seong BYEON, Seoul (KR); Min Jae YOU, Yongin-si (KR)

(21) Appl. No.: 19/234,693

(22) Filed: Jun. 11, 2025

Related U.S. Application Data
(60) Provisional application No. 63/695,438, filed on Sep. 17, 2024.

(51) Int. Cl. H01M 4/131; H01M 4/02; H01M 4/04; H01M 4/36; H01M 4/505; H01M 4/525; H01M 10/0525

(52) U.S. Cl. CPC H01M 4/131; H01M 4/0471; H01M 4/366; H01M 4/505; H01M 4/525; H01M 10/0525; H01M 2004/028

(57) ABSTRACT

An example of the disclosure provides a composite material for a cathode active material and a method for manufacturing the same. A lithium secondary battery, including a high nickel cathode active material (NCM) and a composite material for a cathode active material in which the cathode active material surface is made of a lithium active material (positive electrode coating material), of the disclosure has the effect of improving the overall energy density by compensating for lithium consumed for forming a Solid Electrolyte Interface (SEI) layer of a negative electrode during an initial charge reaction, and suppressing side reactions occurring between an electrolyte and the cathode active material surface through a change to a stable rock-salt crystal structure of a positive electrode coating layer.

### BACKGROUND

The disclosure relates to a cathode active material, and more specifically, to a composite material for a cathode active material having a positive electrode coating agent formed on the surface of the cathode active material, and a method for manufacturing the same.

Lithium secondary batteries are widely applicable as high-performance lithium secondary batteries used as energy sources for mobile information and communication devices such as mobile phones, Personal Digital Assistants (PDAs), camcorders, and laptop computers, as well as secondary batteries for high-power large-scale transportation devices such as electric motors and hybrid electric vehicles (HEVs).

Lithium secondary batteries are generally composed of a positive electrode and a negative electrode that allow insertion and de-insertion of lithium ions, a separator that prevents physical contact between the positive electrode and the negative electrode, and an organic electrolyte or polymer electrolyte that transmits lithium ions. Lithium secondary batteries generate electric energy through electrochemical oxidation and reduction reactions when lithium ions are inserted/de-inserted from the positive electrode and the negative electrode.

Lithium-containing composite oxides, preferably lithium-transition metal oxides, are used as cathode active materials, and recently, various cathode active materials have been proposed as composite materials for cathode active materials in which a heterogeneous material is coated on the surface of the cathode active material.

Korean Patent No. 2152369 relates to a material coated with a metal oxide on the surface, wherein in order to solve the problem that hydrofluoric acid (HF) generated during the side reaction process of the conventional cathode active material and the electrolyte accelerates the deterioration of the positive electrode material and reduces the life characteristics of the lithium secondary battery, a metal oxide coating layer was formed on the surface of the cathode active material to suppress the surface side reaction and secure the life extension characteristic of the lithium secondary battery.

However, the metal oxide coating layer formed on the surface of the cathode active material is an ion insulating layer in which lithium ions are difficult to diffuse and is an electrochemically inactive material, so there is a disadvantage in that the capacity decreases with an increase in the content.

In addition, Korean Patent No. 1777917 is a surface-coated cathode active material, wherein while conventional metal oxide coating layers such as SiO2 and Al2O3 are known to improve the surface stability characteristics of the cathode active material, there was a problem that they were finely dispersed as nanoparticles rather than covering the entire surface of the cathode active material, and to solve this problem, a nano-film containing polyimide (PI) and conductive nanoparticles (Sn, Sb) was coated on the surface of the cathode active material, thereby preventing direct contact between the cathode active material and the electrolyte, effectively suppressing side reactions and improving the life characteristics under high temperature and high voltage conditions.

However, in the case of metal oxides, as an insulator, they cause surface resistance and have much room for improvement for commercialization, and they have the disadvantage of not providing additional lithium, which reduces the energy density of lithium secondary batteries during charge and discharge reactions.

Therefore, there are still many challenges remaining for the development of cathode active materials that solve the above problems.

### RELATED ART

### Patent Document

(Patent document 0001) Republic of Korea Patent Registration No. 2152369

### SUMMARY

An aspect of the disclosure is to provide a composite material for a cathode active material that can secure the surface stability of a positive electrode material while improving the energy density of a lithium secondary battery.

The aspect of the disclosure is not limited to that mentioned above, and other aspects not mentioned will be clearly understood by those skilled in the art from the description below.

An example of the disclosure provides a composite material for a cathode active material.

A composite material for a cathode active material according to an example of the disclosure may include: an NCM-based cathode active material; and a positive electrode coating layer coated on the surface of the NCM-based cathode active material and composed of a positive electrode coating material represented by Chemical Formula 1.

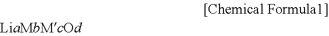

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

In addition, according to an example of the disclosure, in Chemical Formula 1, M may be at least one selected from the group consisting of Ni, Co, Mn and Fe, and M′ may be at least one selected from the group consisting of Ti, V, Nb and Ta.

In addition, according to an example of the disclosure, the NCM-based cathode active material may be represented by Chemical Formula 2.

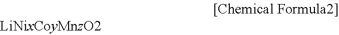

In Chemical Formula 2, 0.5≤x<1.0, 0.0≤y<0.5, 0.0≤z<0.5, and x+y+z=1.

In addition, according to an example of the disclosure, the positive electrode coating material may be coated in an amount of 0.1 to 5 wt % relative to the cathode active material.

In addition, according to an example of the disclosure, the positive electrode coating material may form a rock-salt crystal structure.

In addition, according to an example of the disclosure, the positive electrode coating material forming the rock-salt crystal structure may be composed of Li2NiTiO4, Li2CoTiO4 or Li2MnTiO4.

Another example of the disclosure provides a composite material for a cathode active material.

A composite material for a cathode active material according to an example of the disclosure may include: an NCM-based cathode active material; and a positive electrode coating layer coated on the surface of the NCM-based cathode active material and composed of a positive electrode coating material represented by Chemical Formula 3.

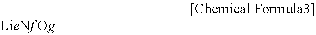

In Chemical Formula 1, 1≤e≤14, 1≤f≤5, and 2≤g≤9.

In addition, according to an example of the disclosure, in Chemical Formula 3, N may be at least one selected from the group consisting of Fe, Ni, Co, and Mn.

In addition, according to an example of the disclosure, the NCM-based cathode active material may be represented by Chemical Formula 2.

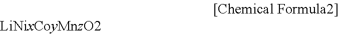

In Chemical Formula 2, 0.5≤x<1.0, 0.0≤y<0.5, 0.0≤z<0.5, and x+y+z=1.

In addition, according to an example of the disclosure, the positive electrode coating material may be coated in an amount of 0.1 to 5 wt % relative to the cathode active material.

Another example of the disclosure provides a method for manufacturing a composite material for a cathode active material.

The method according to an example of the disclosure may include: preparing an NCM-based cathode active material and a positive electrode coating material represented by Chemical Formula 1 or Chemical Formula 3; and
manufacturing a composite material for a cathode active material by mixing the NCM-based cathode active material and a composite material for a cathode active material and heat-treating the same to coat the positive electrode coating material on the surface of the NCM-based cathode active material to form a positive electrode coating layer.

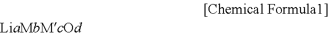

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

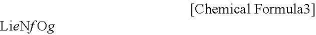

In Chemical Formula 3, N is at least one selected from the group consisting of Fe, Ni, Co, and Mn, 1≤e≤14, 1≤f≤5, and 2≤g≤9.

In addition, according to an example of the disclosure, the heat treatment may be performed in an oxygen atmosphere at a temperature range of 300C to 900C.

In addition, according to an example of the disclosure, when a secondary battery containing the composite material for a cathode active material is charged, the positive electrode coating layer may change into a rock-salt crystal structure.

Another example of the disclosure provides a lithium secondary battery.

The lithium secondary battery includes the above-described composite material for a cathode active material.

A lithium secondary battery, including a high nickel cathode active material (NCM) and a composite material for a cathode active material in which the cathode active material surface is made of a lithium active material (positive electrode coating material), of the disclosure has the effect of improving the overall energy density by compensating for lithium consumed for forming a Solid Electrolyte Interface (SEI) layer of a negative electrode during an initial charge reaction, and suppressing side reactions occurring between an electrolyte and the cathode active material surface through a change to a stable rock-salt crystal structure of a positive electrode coating layer.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B and 1C are schematic diagrams illustrating a method for manufacturing a composite material for a cathode active material;

FIG. 2 is a flow chart illustrating a method for manufacturing a composite material for a cathode active material;

FIGS. 3A, 3B, 3C, and 3D show the results of X-ray diffraction analysis for Comparative Examples 1 and 3 and Example 1;

FIGS. 4A, 4B, 4C, and 4D show the results of X-ray diffraction analysis for Comparative Examples 2 and 3 and Example 2;

FIG. 5 shows the results of SEM and EDS analysis for Comparative Examples 1 and 3 and Example 1;

FIG. 6 shows the results of SEM and EDS analysis for Comparative Examples 2 and 3 and Example 2;

FIGS. 7A, 7B, 7C, 7D, and 7E show the results of measuring the distribution of Ti elements through TEM images and EDS analysis for Example 1 based on Comparative Examples 1 and 3;

FIGS. 8A, 8B, 8C, 8D, 8E, and 8F show the results of measuring the distribution of Fe elements through TEM images and EDS analysis for Example 2 based on Comparative Examples 2 and 3;

FIGS. 9A, 9B, and 9C show the results of Raman analysis for Comparative Examples 1 to 3 and Examples 1 and 2;

FIGS. 10A and 10B show the results of X-ray photoemission spectroscopy (XPS) analysis for Comparative Examples 1 and 3 and Example 1;

FIGS. 11A and 11B show the results of X-ray photoemission spectroscopy (XPS) analysis for Comparative Examples 2 and 3 and Example 2;

FIG. 12 shows the results of analysis for powder conductivity measurement according to pressure for Comparative Example 4 and Example 2;

FIG. 13 shows the results of analysis for electrical conductivity measurement for Comparative Example 4 and Example 2;

FIG. 14 shows the results of impedance analysis for Comparative Example 4 and Example 2;

FIG. 15 shows the results of electrochemical characteristic evaluation for Comparative Examples 1, 2, 3, and 4;

FIG. 16 shows the results of electrochemical characteristic evaluation for Comparative Example 3 and Examples 1 and 2;

FIG. 17 shows the results of the life characteristic evaluation for Comparative Example 3 and Examples 1 and 2;

FIG. 18 shows the results of the electrochemical characteristic evaluation for Comparative Example 3 and Examples 2 and Comparative Example 4;

FIG. 19 shows the results of the life characteristic evaluation for Comparative Example 3 and Examples 2 and Comparative Example 4;

FIG. 20 shows the results of the high-temperature electrochemical characteristic evaluation for Comparative Example 3 and Examples 1 and 2;

FIG. 21 shows the results of the high-temperature life characteristic evaluation for Comparative Example 3 and Examples 1 and 2;

FIG. 22 shows the results of the high-temperature life characteristic evaluation for Comparative Example 3 and Examples 2 and Comparative Example 4;

FIGS. 23A, 23B, 23C, 23D, and 23E show the results of measuring TEM images after the life characteristics of Comparative Example 3 and the results of measuring element distribution through EDS analysis;

FIGS. 24A, 24B, 24C, 24D, and 24E show the results of measuring TEM images after the life characteristics of Example 1 and the results of measuring element distribution through EDS analysis;

FIGS. 25A, 25B, 25C, and 25D show the results of measuring XPS inside the particles after the life characteristics of Comparative Example 3 and Example 1; and

FIGS. 26A, 26B, 26C, and 26D show the results of measuring XPS inside the particles after the life characteristics of Comparative Example 3 and Example 2.

### DETAILED DESCRIPTION

Hereinafter, the disclosure will be described with reference to the accompanying drawings. However, the disclosure may be implemented in various different forms and, therefore, is not limited to the examples described herein. In order to clearly explain the disclosure in the drawings, portions unrelated to the description are omitted, and similar portions are given similar reference numerals throughout the specification.

Throughout the specification, when a portion is said to be “connected (linked, contacted, combined)” with another portion, this includes not only a case of being “directly connected” but also a case of being “indirectly connected” with another member in between. In addition, when a portion is said to “include” a certain component, this does not mean that other components are excluded, but that other components may be added, unless specifically stated to the contrary.

The terms used herein are merely used to describe specific examples and are not intended to limit the disclosure. Singular expressions include plural expressions unless the context clearly dictates otherwise. In this specification, it should be understood terms such as “include” or “have” are to designate the presence of features, numbers, steps, operations, components, parts, or combinations thereof described in the specification, but are not to exclude in advance the possibility of the presence or addition of one or more other features, numbers, steps, operations, components, parts, or combinations thereof.

As the demand for large-scale devices such as conventional electric vehicles (EVs) and energy storage systems (ESSs) increases, research is actively being conducted to increase the energy density of lithium secondary batteries to secure longer driving ranges and operating times.

Among various materials that make this possible, high-nickel NCM-based cathode active materials with a nickel content of 80% or more are attracting attention, and these high-nickel NCM-based cathode active materials can realize high reversible capacities (≥200 mAh/g) through the redox reaction of Ni2+/Ni4+ compared to conventional layered lithium cobalt oxide (LiCoO2, to 150 mAh/g).

However, as the nickel content increases, thermal and structural instabilities are accelerated, which is the main cause of cell performance degradation. In particular, various coating materials have been studied to solve these problems, but capacity decreases as the coating content increases.

An aspect of the disclosure is to solve the above technical problem, which is to provide a composite material for a cathode active material, including a novel coating material that can improve the stability of the surface of NCM-based cathode active material by coating a stable LMM′O lithium active material as a positive electrode coating material on the surface of NCM-based cathode active material and electrochemically compensate for additional lithium to improve the energy density and life characteristics of lithium secondary batteries.

Hereinafter, examples of the disclosure will be described in detail with reference to the accompanying drawings.

A composite material for a cathode active material according to an example of the disclosure will be described.

A composite material for a cathode active material according to an example of the disclosure includes: an NCM-based cathode active material; and a positive electrode coating layer coated on the surface of the NCM-based cathode active material and composed of a positive electrode coating material represented by Chemical Formula 1.

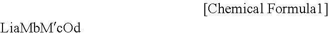

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

First, a composite material for a cathode active material according to an example of the disclosure may include an NCM-based cathode active material.

The cathode active material refers to a material that receives electrons and is reduced together with a cation, and is a material that accounts for 40% of the total material cost of a lithium-ion battery.

At this time, the cathode active material according to an example of the disclosure may use an NCM-based positive electrode material, and may use high-nickel having a nickel ratio of 60 at % or more.

At this time, the NCM-based cathode active material according to an example of the disclosure is characterized by being represented by the following Chemical Formula 2.

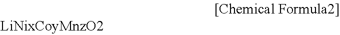

In Chemical Formula 2, 0.5≤x<1.0, 0.0≤y<0.5, 0.0≤z<0.5, and x+y+z=1.

For example, NCM811 (LiNi0.8Co0.1Mn0.1O2) containing 80% nickel, 10% cobalt, and 10% manganese may be used.

In addition, a composite material for a cathode active material according to an example of the disclosure may include a positive electrode coating layer.

The positive electrode coating layer is coated on the surface of the NCM-based cathode active material, and is composed of a positive electrode coating material represented by Chemical Formula 1.

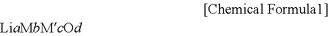

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

The disclosure uses a material in which M of Chemical Formula 1 is at least one metal element forming a divalent cation or a trivalent cation as a positive electrode coating material, and M′ is at least one metal element forming a tetravalent cation.

In the case of the material M, an effect of implementing additional capacity by a reversible electrochemical redox reaction may be derived, and since the metal used as the material M′ maintains an electrochemically inactive state and maintains a strong bond with oxygen, an effect of suppressing irreversible loss of oxygen atoms due to anion redox reaction may be derived.

In addition, preferably, in the Chemical Formula 1, M may be at least one metal selected from the group consisting of Ni, Co, Mn, and Fe, and M′ may be at least one metal selected from the group consisting of Ti, V, Nb, and Ta.

In addition, the positive electrode coating material according to an example of the disclosure is coated in an amount of 0.1 wt % to 5 wt % relative to the cathode active material.

In this case, if the positive electrode coating material is coated in an amount of 0.1 wt % or less relative to the cathode active material, there may be a problem of performance degradation of the LMM′O lithium active layer, and if the positive electrode coating material is coated in an amount exceeding 5 wt % relative to the cathode active material, there may be a problem of electrochemical performance degradation of the NCM-based cathode active material due to particle agglomeration caused by the formation of an excessive coating layer.

As such, the disclosure is characterized by coating a LiaMbM′cOd (LMM′O) lithium active material capable of electrochemically compensating for lithium on the surface of a NCM-based cathode active material composed of LiNixCoyMnzO2, and then heat-treating to form a positive electrode coating layer on the surface of a high-nickel positive electrode material.

At this time, when the composite material for cathode active material formed by coating the LMM′O lithium active material and then heat-treating is applied to a lithium secondary battery, the loss of lithium ions used to form a solid electrolyte interface (SEI) of the negative electrode during initial charging can be effectively compensated.

At this time, the SEI layer prevents the performance of the lithium ion battery from suddenly deteriorating when the lithium ion battery is first charged, so that the solvent molecules in the electrolyte may cover the lithium ions, and when the electrons reach the negative graphite, the lithium ions may react with the graphite together with the solvent molecules to form an SEI layer.

At this time, the SEI layer can prevent the direct contact between the electrons and the electrolyte, thereby preventing the electrolyte from being decomposed.

That is, the SEI can prevent additional decomposition of the electrolyte and allow lithium ion transport while blocking the movement of electrons to ensure continuous electrochemical reaction.

At this time, about 5% of lithium can be consumed in the overall formation and performance of the SEI layer.

Accordingly, the positive electrode coating layer of the composite material for a cathode active material according to an example of the disclosure can effectively compensate for the loss of lithium ions used to form the Solid Electrolyte Interface (SEI) of the negative electrode during the initial charge, thereby improving the energy density of the lithium secondary battery.

At this time, the charge compensation principle of the positive electrode coating layer effectively compensates for the loss of lithium ions used to form the Solid Electrolyte Interface (SEI) of the negative electrode.

In addition, the composite material for a cathode active material according to an example of the disclosure may form a stable rock-salt crystal structure on the surface of the high-nickel positive electrode material (cathode active material) after the first charge.

The positive electrode coating material forming the above rock-salt crystal structure may be composed of Li2NiTiO4, Li2CoTiO4, or Li2MnTiO4.

At this time, when the rock-salt crystal structure is formed, the unstable surface of the NCM-based cathode active material can be protected, thereby improving surface stability.

The principle of the rock-salt crystal structure protecting the unstable surface and improving surface stability is that the structural stability of the rock-salt crystal structure can suppress irreversible phase transition occurring on the surface of the cathode active material, and direct contact between the cathode active material and the electrolyte can be suppressed, thereby suppressing surface side reactions.

At this time, the positive electrode coating material is represented as Li2NiTiO4 and may have peaks at 43.8 degrees and 76.3 degrees corresponding to the (200) and (311) plane directions of the Fm-3m space group of the cubic system in X-ray diffraction analysis.

In addition, the Li2NiTiO4 positive electrode coating material may have a plane distance of 0.214 nm to 0.219 nm in the (200) plane direction as a result of TEM analysis.

In addition, the Li2NiTiO4 positive electrode coating material may have a large intensity in the Raman transition region of the peak appearing in the 100 to 200 region, the 300 to 500 region, and the 600 to 800 region as a result of Raman spectrum analysis.

In addition, the Li2NiTiO4 positive electrode coating material may have binding energy values corresponding to 854.08 (Ni²⁺) and 855.48 eV (Ni³⁺) regions in Ni 2p and 459.28 (Ti⁴⁺) and 464.78 eV (Ti⁴⁺) regions in Ti 2p as a result of XPS analysis.

Specific proof regarding the experiment of the positive electrode coating material will be described in detail in the Experimental Examples below.

Therefore, the composite material for cathode active material according to an example of the disclosure includes a positive electrode coating layer on the surface of the cathode active material, thereby compensating for lithium consumed for forming a solid electrolyte interface (SEI) layer of the negative electrode during the initial charge reaction, thereby improving the overall energy density, and suppressing side reactions occurring between the electrolyte and the surface of the cathode active material through the change of the LMM′O coating layer into a stable rock-salt crystal structure.

Hereinafter, a composite material for cathode active material according to another example of the disclosure is described.

The composite material for a cathode active material may include: an NCM-based cathode active material; and a positive electrode coating layer coated on the surface of the NCM-based cathode active material and composed of a positive electrode coating material represented by Chemical Formula 3.

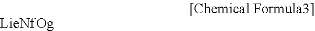

In Chemical Formula 3, N may be at least one metal element from groups 3 to 12 and periods 4 to 7, 1≤e≤14, 1≤f≤5, and 2≤g≤9.

In addition, N may be at least one selected from the group consisting of Fe, Ni, Co, and Mn.

In addition, the NCM-based cathode active material may be represented by Chemical Formula 2.

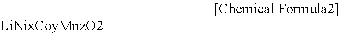

In Chemical Formula 2, 0.5≤x<1.0, 0.0≤y<0.5, 0.0≤z<0.5, and x+y+z=1.

In addition, the positive electrode coating material may be coated in an amount of 0.1 wt % to 5 wt % relative to the cathode active material.

In addition, the composite material for a cathode active material according to an example of the disclosure may have an orthorhombic crystal structure on the surface of a high-nickel positive electrode material (cathode active material) after the first charge.

At this time, the positive electrode coating material forming the orthorhombic crystal structure may be composed of Li5FeO4, Li5NiO4, Li5MnO4, or Li6NiO4.

In addition, the composite material for a cathode active material according to an example of the disclosure may have a tetragonal crystal structure on the surface of a high-nickel positive electrode material (cathode active material) after the first charge.

At this time, the positive electrode coating material forming the tetragonal crystal structure may be composed of Li5FeO4, Li5NiO4, Li5Mn04, or Li6NiO4.

In addition, the composite material for a cathode active material according to an example of the disclosure may have a trigonal crystal structure on the surface of the high-nickel positive electrode material after the first charge.

At this time, the positive electrode coating material forming the trigonal crystal structure may be composed of Li14Mn209.

At this time, the X-ray diffraction analysis of the Li5FeO4 positive electrode coating material may have peaks at 21.5 degrees, 23.6 degrees, and 33.7 degrees corresponding to the (210), (121), and (222) plane directions of the Pbca space group of the orthorhombic system.

In addition, the TEM analysis results of the Li5FeO4 positive electrode coating material may show that the interplanar distance in the (111) plane direction corresponds to 0.53 nm, the interplanar distance in the (222) plane direction may correspond to 0.26 nm, and the interplanar distance in the (323) plane direction may correspond to 0.19 nm.

In addition, the peaks appearing in the Raman transition region as a result of the Raman spectrum analysis may have large intensities in the 100 to 200 range, the 300 to 500 range, and the 600 to 800 range.

In addition, the XPS analysis result may have binding energy values corresponding to the 710.78 (Fe³⁺) and 724.08 eV (Fe³⁺) ranges in Fe 2p.

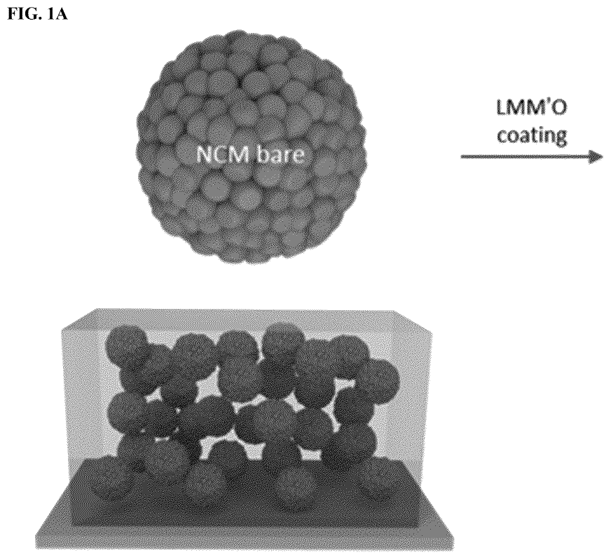

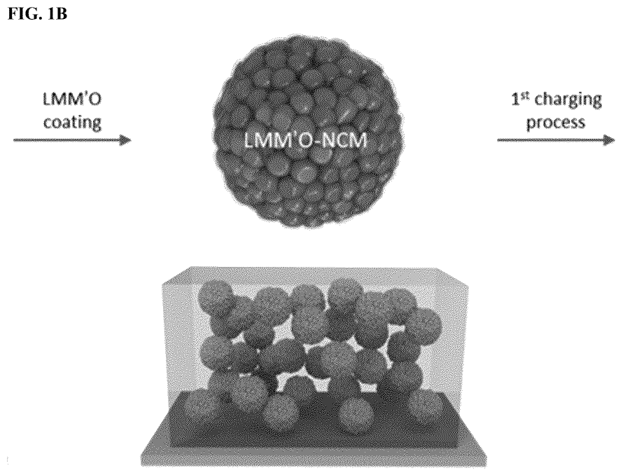

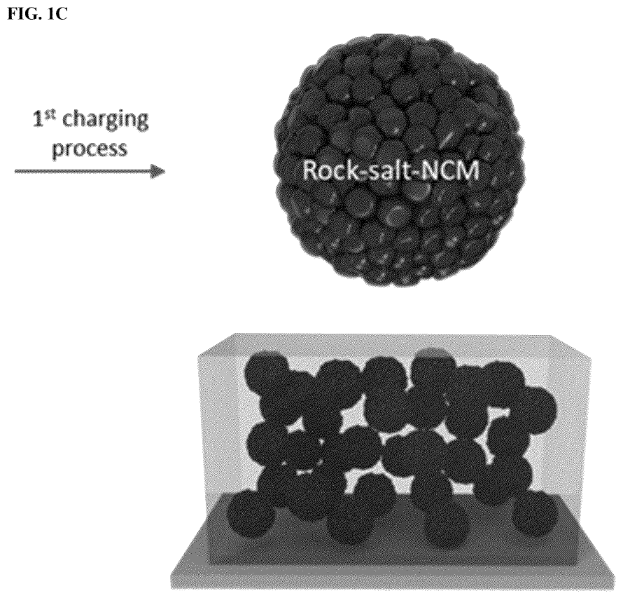

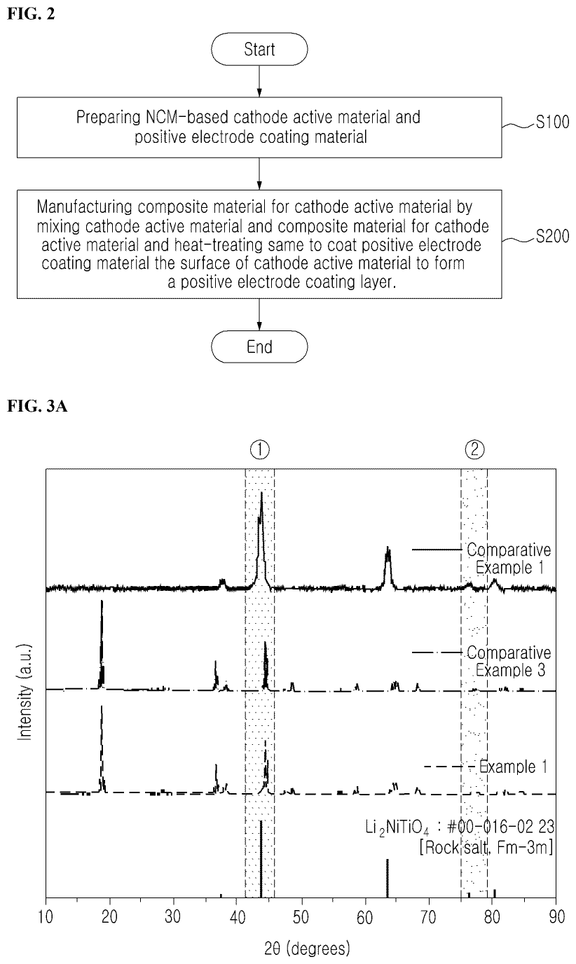

Referring to FIGS. 1 and 2, a method for manufacturing a composite material for a cathode active material according to another example of the disclosure will be described.

FIG. 1 is a schematic diagram illustrating a method for manufacturing a composite material for a cathode active material.

FIG. 2 is a flow chart illustrating a method for manufacturing a composite material for a cathode active material.

A method for manufacturing a composite material for a cathode active material according to an example of the disclosure may include: preparing an NCM-based cathode active material and a positive electrode coating material represented by Chemical Formula 1 or Chemical Formula 3 (S100); and manufacturing a composite material for a cathode active material by mixing the NCM-based cathode active material and a composite material for a cathode active material and heat-treating the same to coat the positive electrode coating material on the surface of the NCM-based cathode active material to form a positive electrode coating layer (S200).

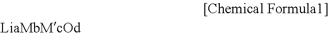

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

In the first step, preparing a composite material for an NCM-based cathode active material and a cathode active material represented by Chemical Formula 1 may be included. (S100)

At this time, the NCM-based cathode active material used in the disclosure may include a material represented by Chemical Formula 2, but is not limited to the examples described above.

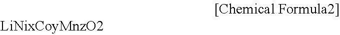

In Chemical Formula 2, 0.5≤x<1.0, 0.0≤y<0.5, 0.0≤z<0.5, and x+y+z=1.

In addition, the positive electrode coating material according to an example of the disclosure may include a material represented by Chemical Formula 1 or Chemical Formula 3.

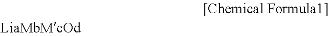

In Chemical Formula 1, M is at least one of a metal element forming a divalent cation or a trivalent cation, M′ is at least one of a metal element forming a tetravalent cation, 2≤a≤14, 1≤b≤2, 0≤c≤1, and 4≤d≤9.

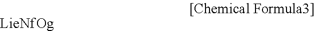

In Chemical Formula 3, N is at least one metal element from groups 3 to 12 and periods 4 to 7, 1≤e≤14, 1≤f≤5, and 2≤g≤9.

Specifically, in order to synthesize a positive electrode coating material represented by Li2NiTiO4 among the positive electrode coating materials represented by Chemical Formula 1, CH3COOLi·2H2O:(CH3COO)2Ni·4H2O:Ti[OC(CH3)]4 as a precursor may be synthesized at a molar ratio of 2:1:1 to 2.6:1:1.

In addition, in order to synthesize a positive electrode coating material represented by Li5FeO4 among the positive electrode coating materials represented by Chemical Formula 3, precursor LiOH·H2O:FeO(OH) may be synthesized at a molar ratio of 4:1 to 6:1.

In the second step, mixing the cathode active material and the positive electrode coating material and performing heat treatment to coat the positive electrode coating material on the surface of the cathode active material to form a positive electrode coating layer, thereby manufacturing a composite material for the cathode active material may be included. (S200)

The heat treatment for coating the positive electrode coating material represented by the Chemical Formula 1 on the cathode active material may be performed in an oxygen atmosphere at a temperature range of 300° C. to 700° C.

At this time, the heat treatment may change from an amorphous rock salt structure state to a crystalline rock salt structure state.

In addition, the heat treatment for coating the positive electrode coating material represented by Chemical Formula 3 on the cathode active material may be performed in an oxygen atmosphere at a temperature range of 600° C. to 900° C.

At this time, the heat treatment may change from a LiFeO2 state to a Li5FeO4 state.

In addition, when a secondary battery including a composite material for a cathode active material according to an example of the disclosure is charged, the positive electrode coating layer may change into a rock-salt crystal structure, and the principle is that an irreversible phase transition occurs as lithium escapes outside the crystal structure.

A lithium secondary battery according to another example of the disclosure will be described.

The lithium secondary battery includes the above-described composite material for a cathode active material.

At this time, the electrolyte in the secondary battery is characterized by including a material in which 1.0 M LiPF6 is mixed with a material in which ethylene carbonate (EC) and ethyl methyl carbonate (EMC) are mixed in a ratio of 1:2.

Hereinafter, the disclosure will be described in more detail through Manufacturing Examples and Experimental Examples. These Manufacturing Examples and Experimental Examples are only for illustrating the disclosure, and the scope of the disclosure is not limited by these Manufacturing Examples and Experimental Examples.

### Comparative Example 1: Manufacturing of Li2NiTiO4 Positive Electrode Coating Material

First, in order to manufacture a positive electrode coating material corresponding to Li2NiTiO4, 1 mol of CH3COO)2Ni·4H2O and 1 mol of Ti[OC(CH3)]4 were mixed.

Next, anhydrous ethanol was evaporated and dried at 80° C. for 2 hours.

Next, the temperature was increased at 5° C. per minute to 600° C. and calcined at that temperature for 5 hours.

Next, the calcined product was cooled and pulverized to obtain a powdered Li2NiTiO4 product.

### Comparative Example 2: Manufacturing of Li5FeO4 Positive Electrode Coating Material

First, to manufacture Li5FeO4 positive electrode coating material, 5.5 mol of LiOH·H2O and 1 mol of FeO(OH) were mixed.

Next, anhydrous ethanol was evaporated and dried at 120° C. for 12 hours.

Next, the temperature was increased to 800° C. at 5° C. per minute and then calcined at that temperature for 12 hours.

Next, the calcined product was cooled and pulverized to obtain a Li5FeO4 powdered product.

### Comparative Example 3: Commercial NCM811 Material

A commercial NCM811 material with a size of 9 μm that did not form a coating layer was used as a cathode active material.

### Comparative Example 4: Li5FeO4-NCM Physical Mixing Positive Electrode Material

First, LiOH·H2O and FeO(OH) were mixed in anhydrous ethanol at a molar ratio of 5.5:1.

Next, the anhydrous ethanol was removed by stirring at 200 rpm for 2 hours, and then dried in a vacuum oven at 120° C.

Next, the temperature was increased to 800° C. at 5° C. per minute in a sintering furnace and maintained at the increased temperature for 12 hours.

Next, the sintered product was cooled and pulverized to obtain Li5FeO4 powder, and then 2 wt % of the central particle NCM was physically mixed to obtain Li5FeO4 physical mixing positive electrode material.

### Example 1: Li2NiTiO4-NCM Composite Positive Electrode Material

First, the molar ratio of CH3COOLi·2H2O:(CH3COO)2Ni·4H2O:Ti[OC(CH3)]4 was set to 2:1:1 and stirred in anhydrous ethanol at 2 wt % relative to the core particle NCM.

Next, the NCM core particle and positive electrode coating material were stirred at 200 rpm for 2 hours to remove the anhydrous ethanol and dried at 80° C. for 2 hours.

Next, the temperature was increased to 600° C. at 5° C. per minute in a sintering furnace and maintained at the increased temperature for 5 hours to obtain a Li2NiTiO4-NCM composite positive electrode material.

### Example 2: Li5FeO4-NCM Composite Positive Electrode Material

First, the molar ratio of LiOH·H2O and FeO(OH) was 5.5:1, and 2 wt % of the core particle NCM was stirred in anhydrous ethanol.

Next, the core particle and the coating material were stirred at 200 rpm for 2 hours to remove the anhydrous ethanol, and then dried in a vacuum oven at 120° C.

Next, the temperature was increased to 800° C. at 5° C. per minute in a sintering furnace and maintained at the increased temperature for 12 hours.

Next, the sintered product was cooled and pulverized to obtain a Li5FeO4-NCM composite positive electrode material.

The content ratio and manufacturing conditions of cathode active material for Comparative Examples 1, 2, 3, and 4 and Examples 1 and 2 are summarized in Table 1 below.

TABLE 1

| | | [symbol] thode | | | | | |
|---|---|---|---|---|---|---|---|
| | | [symbol] tive | | | | | |
| | | [symbol] aterial | | | | | [symbol] eat |
| | [symbol] thode | [symbol] eight % | [symbol] eight % | [symbol] eight % | | [symbol] rying | [symbol] eatment |
| | [symbol] tive | [symbol] core | [symbol] coating | [symbol] mixture | | [symbol] mpera | [symbol] mperatu |
| | [symbol] aterial | [symbol] aterial | [symbol] aterial | [symbol] aterial | [symbol] olvent | [symbol] re | [symbol] |
| [symbol] ompara | [symbol] i2NiTiO4 | [symbol] 00% | | | [symbol] nhydrous | [symbol] 0° C. | [symbol] 00° C. |
| [symbol] ve | | | | | [symbol] hanol | | |
| [symbol] xample | | | | | | | |
| [symbol] ompara | [symbol] i5FeO4 | [symbol] 00% | | | [symbol] nhydrous | [symbol] 0° C. | [symbol] 00° C. |
| [symbol] ve | | | | | [symbol] hanol | | |
| [symbol] xample | | | | | | | |
| [symbol] ompara | CM811 | [symbol] 00% | | | | | |
| [symbol] ve | | | | | | | |
| [symbol] xample | | | | | | | |
| [symbol] ompara | CM811 | [symbol] % | | [symbol] % | [symbol] nhydrous | | |
| [symbol] ve | | | | | [symbol] hanol | | |
| [symbol] xample | | | | | | | |
| [symbol] xample | CM811 | [symbol] % | [symbol] % | | [symbol] nhydrous | [symbol] 0° C. | [symbol] 00° C. |
| | | | | | [symbol] hanol | | |
| [symbol] xample | CM811 | [symbol] % | [symbol] % | | [symbol] nhydrous | [symbol] 0° C. | [symbol] 00° C. |
| | | | | | [symbol] hanol | | |

[symbol]

indicates data missing or illegible when filed

### Example 3: Electrode Manufacturing Using Comparative Example 4, Example 1, Example 2 Composite Materials for Cathode Active Material

First, the materials from Comparative Example 3, Comparative Example 4, Example 1, and Example 2 were used as the cathode active material, and carbon black conductive material and polyvinylidene fluoride (PVdF) were used in a weight ratio of 94:3:3, with N-methylpyrrolidone (NMP) used as a solvent to manufacture a slurry.

Next, the positive electrode slurry was coated on aluminum foil to a thickness of 50 μm, dried, roll pressed, and then dried at 120° C. for 12 hours in a vacuum to manufacture an electrode.

### Evaluation Example: Life Characteristics Evaluation

To evaluate the electrochemical performance, the electrodes of Examples 1 and 2 were used, and the electrolyte was a solution in which 1 mol of LiPF6 was dissolved in a solvent where EC (ethylene carbonate) and EMC (ethyl methyl carbonate) were mixed in a volume ratio of 1:2, to manufacture a conventional coin cell.

At this time, for the battery manufactured as above, the voltage range of charge and discharge at room temperature (25° C.) was 2.5 V to 4.3 V vs. Li/Li⁺, and the initial charge and discharge evaluation was performed at 0.1C/0.1C.

In addition, the life characteristic evaluation was performed by charging and discharging at 0.5C/0.5C. (1.0C=200 mAh/g).

### Experimental Example 1: X-Ray Diffraction Analysis Results of Comparative Examples and Examples

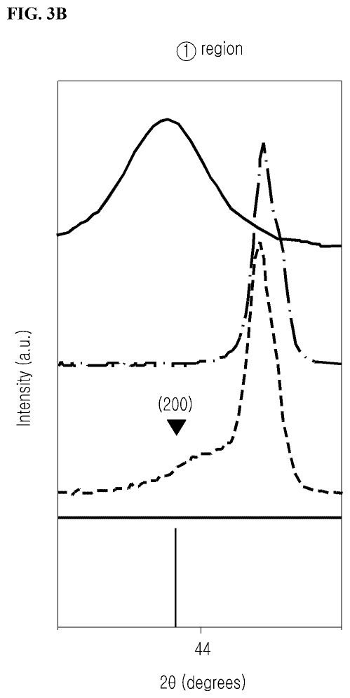

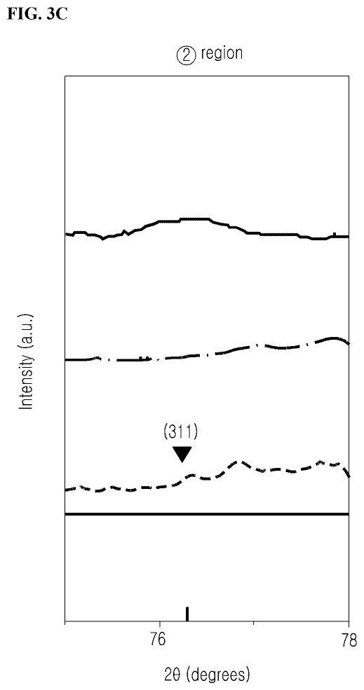

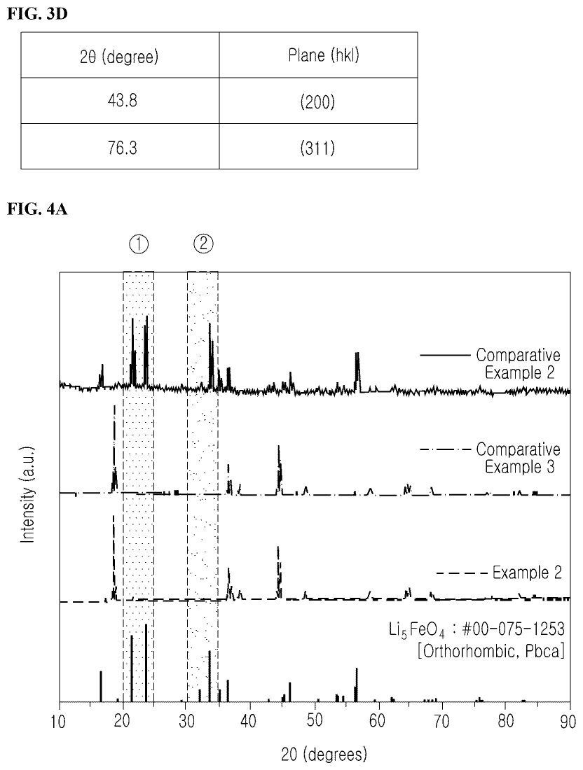

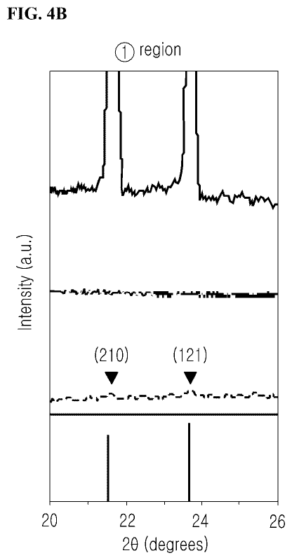

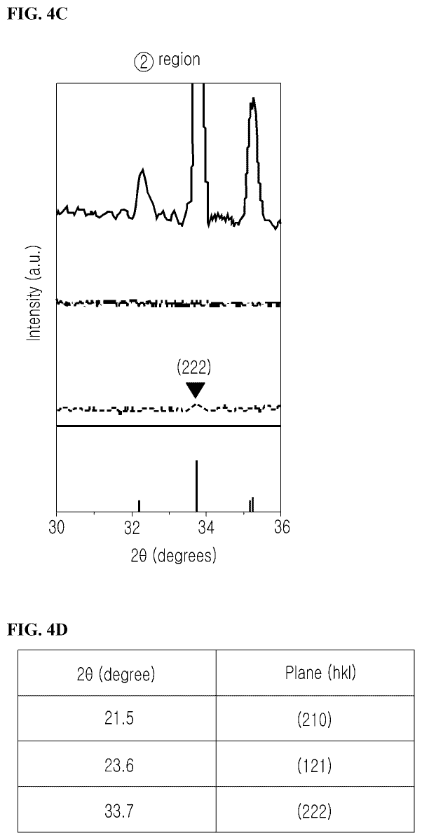

Referring to FIGS. 3 and 4, the X-ray diffraction analysis results of Comparative Examples and examples will be described.

FIGS. 3A, 3B, 3C, and 3D show the results of X-ray diffraction analysis for Comparative Examples 1 and 3 and Example 1.

Referring to FIGS. 3A, 3B, 3C, and 3D, Comparative Example 1 was able to confirm the crystal structure (Fm-3m, rock-salt) of existing Li2NiTiO4, and Comparative Example 3 was able to confirm the crystal structure (R-3m, hexagonal) of high-nickel NCM.

Therefore, Example 1 enables to confirm the X-ray diffraction analysis results in which the crystal structures of Comparative Examples 1 and 3 coexist.

FIG. 4 shows the results of X-ray diffraction analysis for Comparative Examples 2 and 3 and Example 2.

Referring to FIG. 4, Comparative Example 2 enables to confirm the crystal structure (Pbca, orthorhombic) of the existing Li5FeO4, and Comparative Example 3 enables to confirm the crystal structure (R-3m, hexagonal) of the high-nickel NCM.

Therefore, Example 2 enables to confirm the X-ray diffraction analysis results in which the crystal structures of Comparative Examples 2 and 3 coexist.

### Experimental Example 2: SEM, EDS Analysis Results of Comparative Examples and Examples

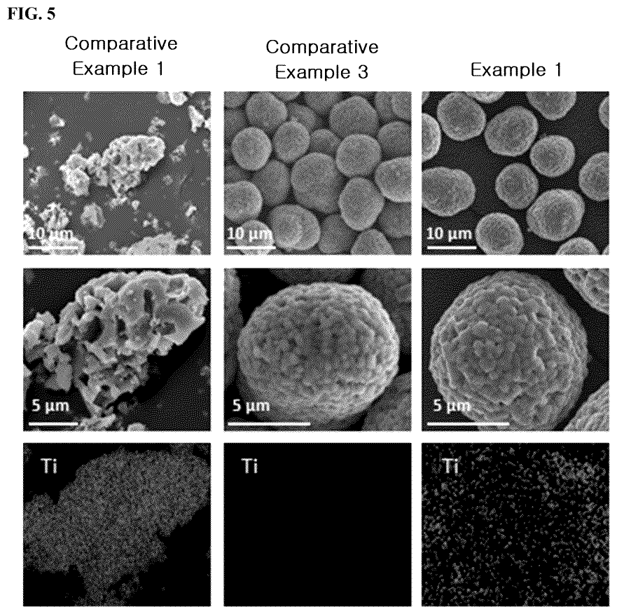

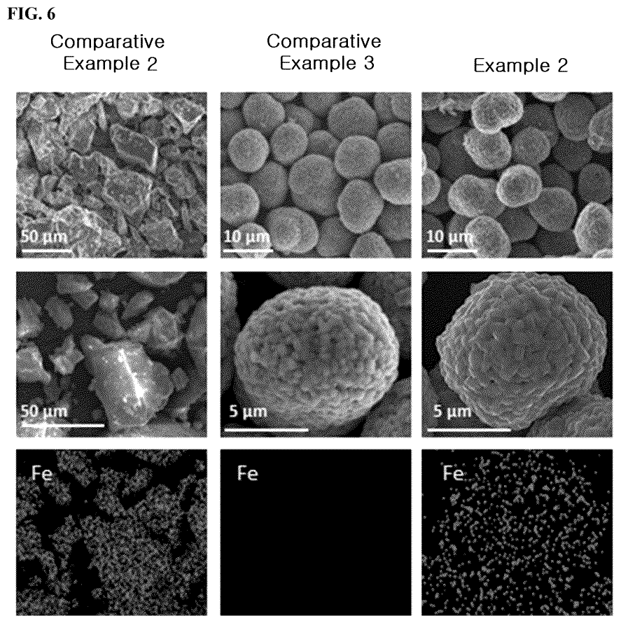

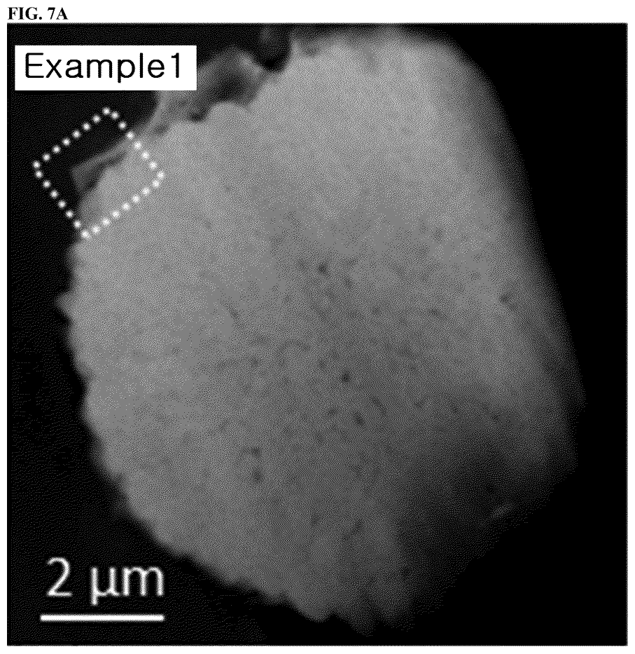

Referring to FIGS. 5 and 6, the element distribution formed on the particle surface of Comparative Examples and Examples is explained.

FIG. 5 shows the results of SEM and EDS analysis for Comparative Examples 1 and 3 and Example 1.

FIG. 5 shows the results of measuring scanning electron microscopy (SEM) images and measuring the distribution of Ti elements through EDS (energy dispersive spectroscopy) analysis for materials manufactured in Comparative Examples 1 and 3 and Example 1.

Referring to FIG. 5, the uniform distribution of Ti elements on the particle surface of the material manufactured in Example 1 could be confirmed through EDS mapping.

FIG. 6 shows the results of SEM and EDS analysis for Comparative Examples 2 and 3 and Example 2.

FIG. 6 shows the results of measuring scanning electron microscopy (SEM) images and measuring the distribution of Fe elements through energy dispersive spectroscopy (EDS) analysis for materials manufactured in Comparative Examples 2 and 3 and Example 2.

Referring to FIG. 6, the uniform distribution of Fe elements on the particle surface of the material manufactured in Example 2 could be confirmed through EDS mapping.

### Experimental Example 3: TEM, EDS Analysis Results of Comparative Examples and Examples

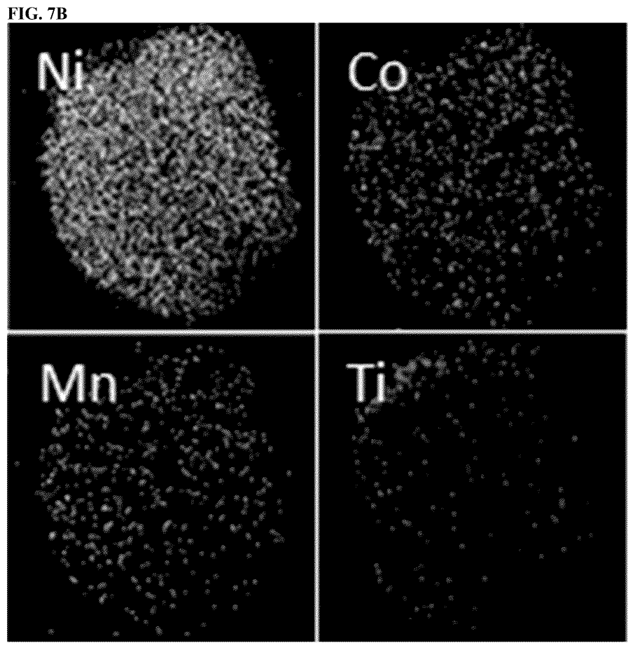

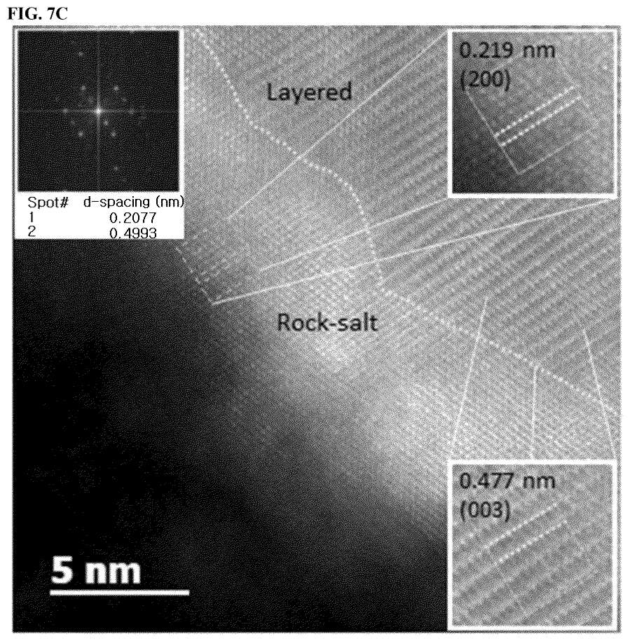

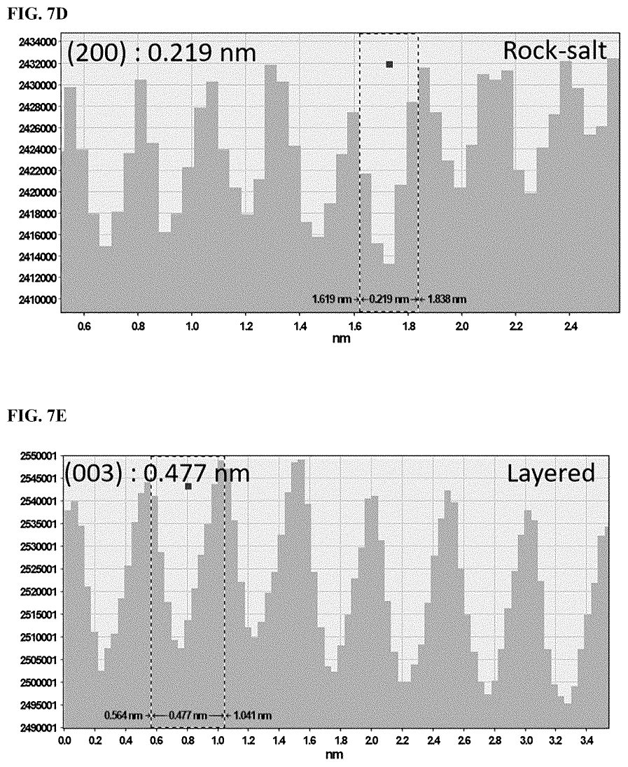

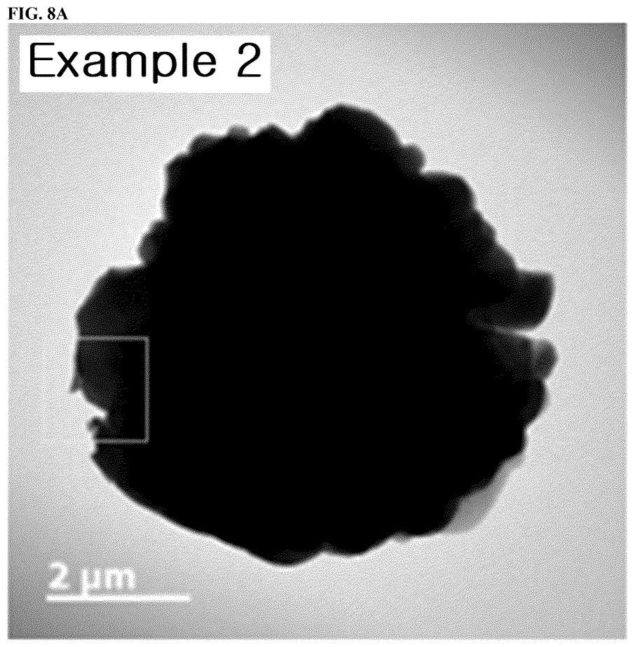

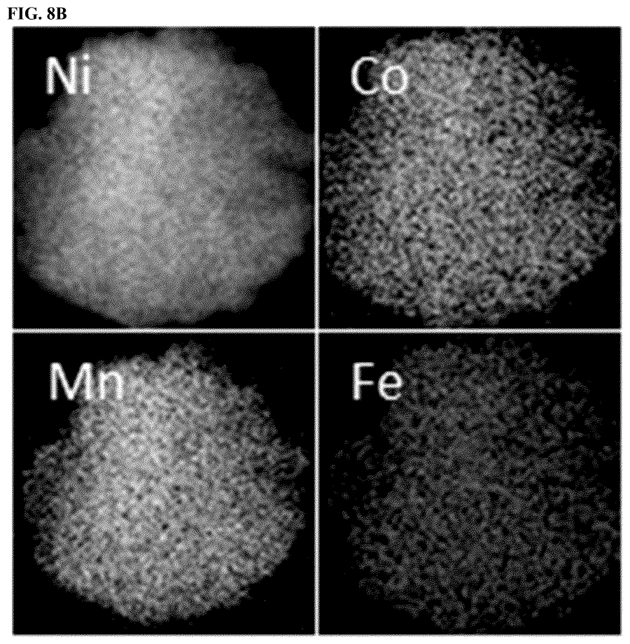

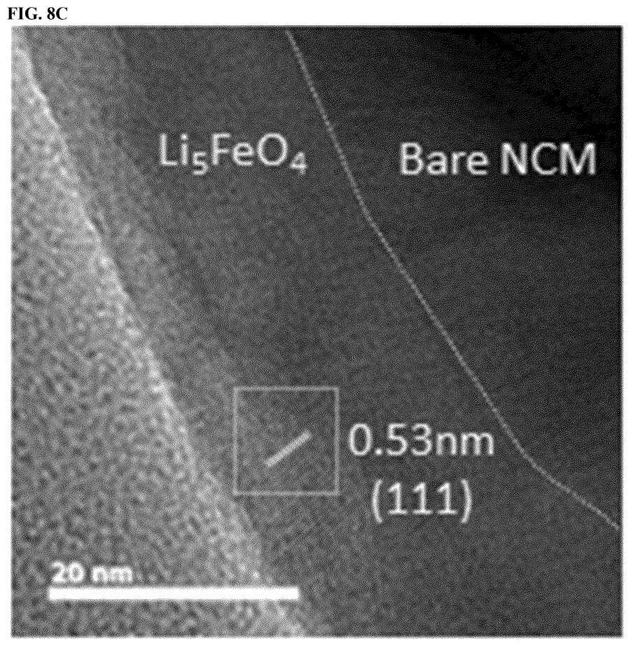

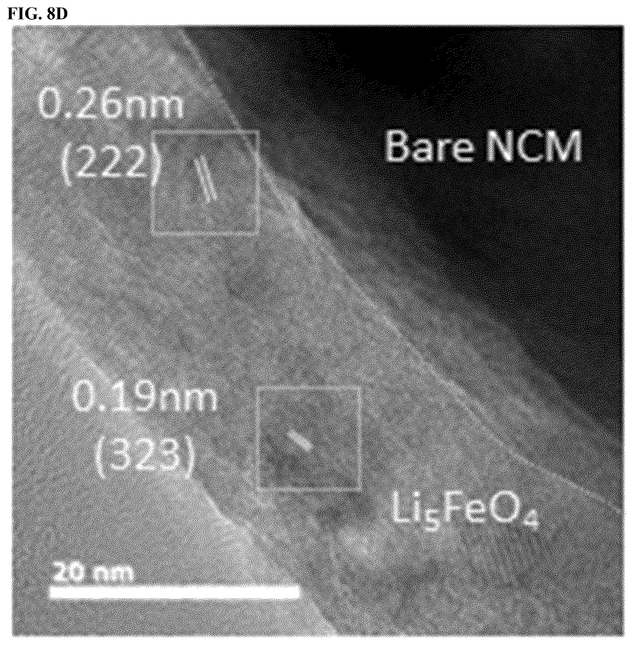

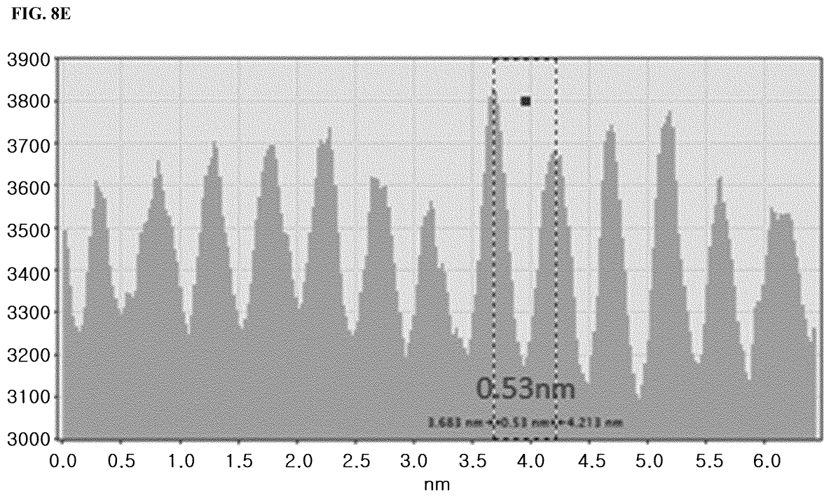

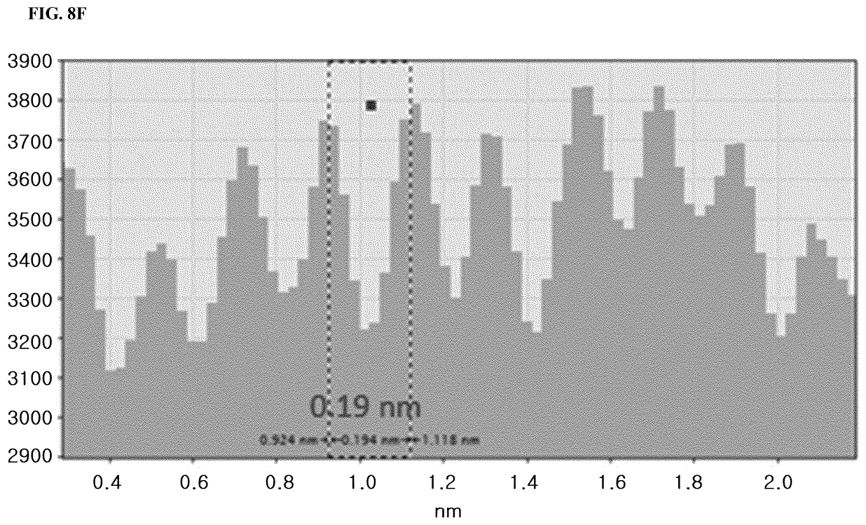

Referring to FIGS. 7 and 8A, 8B, 8C, 8D, 8E, and 8F, the element distribution formed on the particle surface of Comparative Examples and Examples is explained.

FIGS. 7A, 7B, 7C, 7D, and 7E show the results of measuring the distribution of Ti elements through TEM images and EDS analysis for Example 1 based on Comparative Examples 1 and 3.

FIGS. 7A, 7B, 7C, 7D, and 7E show the results of measuring the transmission electron microscopy (TEM) image and measuring the Ti element distribution through energy dispersive spectroscopy (EDS) analysis for Example 1 based on Comparative Examples 1 and 3.

Referring to FIGS. 7A, 7B, 7C, 7D, and 7E, since the inter-surface distance (0.219 nm) for Comparative Example 1 was confirmed in the analysis results of Example 1, it can be confirmed that Comparative Example 1 was coated on the surface of Comparative Example 3.

FIGS. 8A, 8B, 8C, 8D, 8E, and 8F show the results of measuring the distribution of Fe elements through TEM images and EDS analysis for Example 2 based on Comparative Examples 2 and 3.

FIGS. 8A, 8B, 8C, 8D, 8E, and 8F show the results of measuring the Fe element distribution through energy dispersive spectroscopy (EDS) analysis for Example 2 based on Comparative Examples 2 and 3.

Referring to FIGS. 8A, 8B, 8C, 8D, 8E, and 8F, the analysis results of Example 2 enables to confirm the inter-surface distance (0.53 nm, 0.19 nm) for Comparative Example 2, so it can be confirmed that Comparative Example 2 was coated on the surface of Comparative Example 3.

### Experimental Example 4: Raman Analysis and XPS Analysis Results of Comparative Examples and Examples

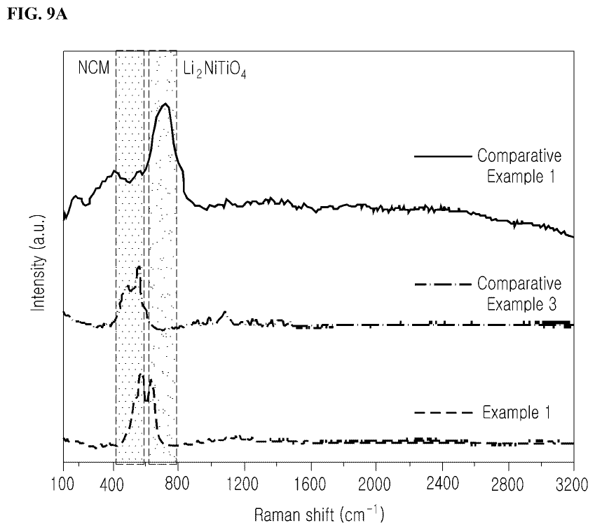

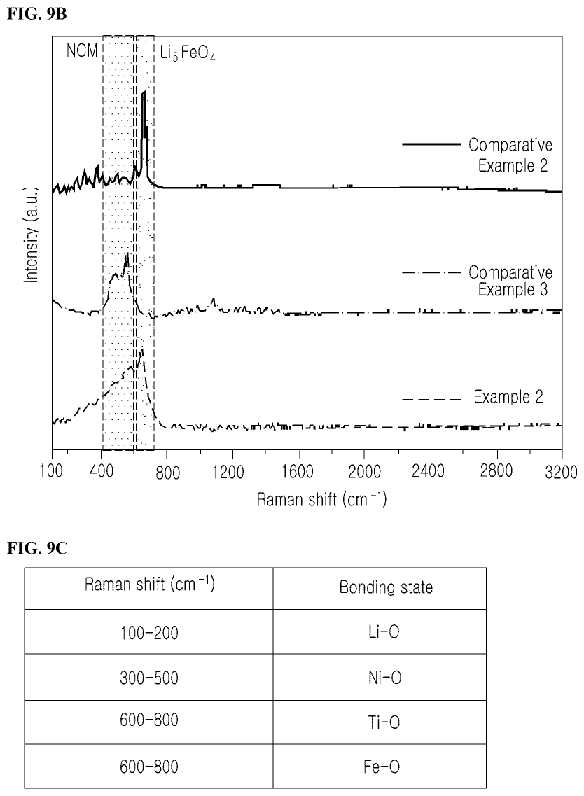

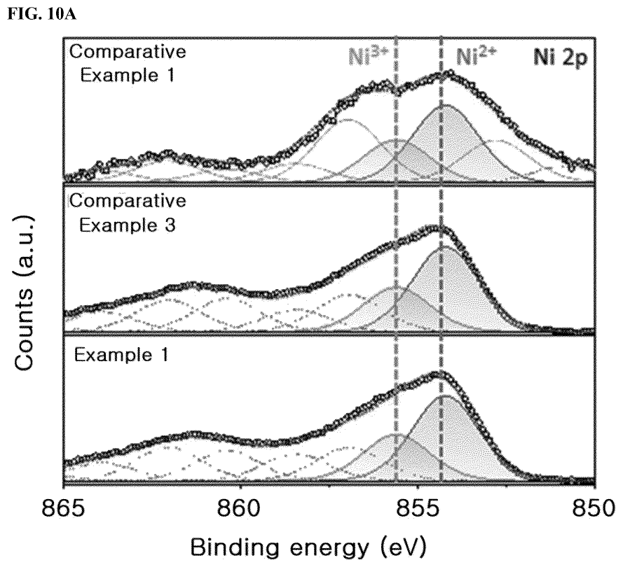

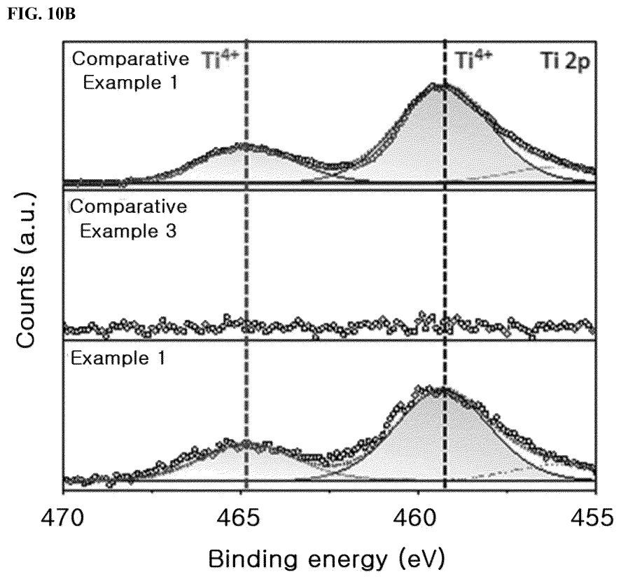

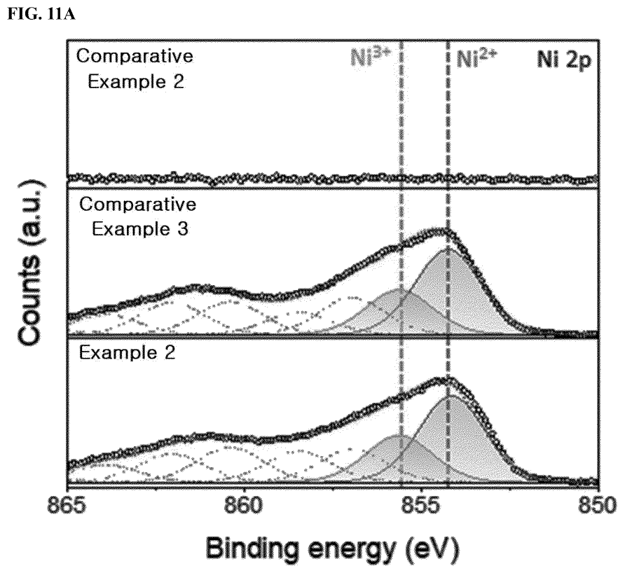

Referring to FIGS. 9 and 10A and 10B, the crystal structures of Comparative Examples and Examples will be described.

FIGS. 9A, 9B, and 9C show the results of Raman analysis for Comparative Examples 1 to 3 and Examples 1 and 2.

FIGS. 9A, 9B, and 9C show the results of Raman analysis for Comparative Examples 1 to 3 and Examples 1 and 2.

As can be seen in FIGS. 9A and 9B, in the case of Example 1, it was confirmed that the crystal structures for Comparative Examples 1 and 3 coexisted, and in the case of Example 2, it was confirmed that the bonding structures for Comparative Examples 2 and 3 coexisted.

FIGS. 10A and 10B show the results of X-ray photoemission spectroscopy (XPS) analysis for Comparative Examples 1 and 3 and Example 1.

FIGS. 10A and 10B show the results of X-ray photoemission spectroscopy (XPS) analysis for Comparative Examples 1 and 3 and Example 1.

Referring to FIGS. 10A and 10B, it can be confirmed that the bonding structures for Comparative Examples 1 and 3 coexist in the analysis results of Example 1 through the Ni 2p and Ti 2p values.

In addition, the XPS analysis results show that the binding energy of Li2NiTiO4 exists in the range of 854.08 (Ni²⁺), 855.48 eV (Ni³⁺) for Ni 2p and 459.28 (Ti⁴⁺), 464.78 eV (Ti4+) for Ti 2p.

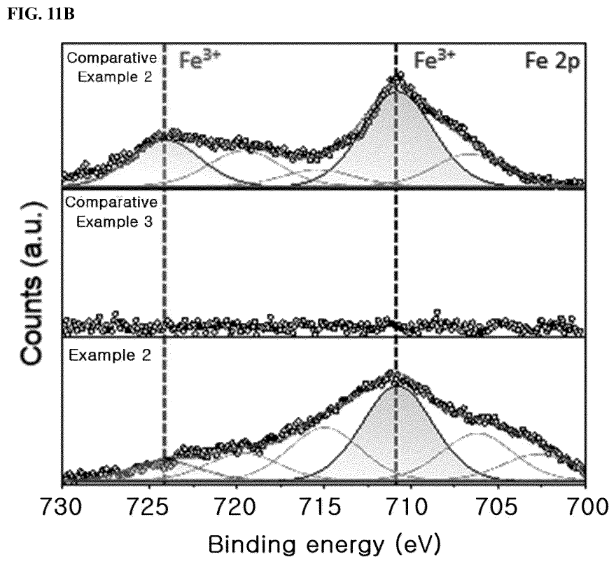

FIGS. 11A and 11B show the results of X-ray photoemission spectroscopy (XPS) analysis for Comparative Examples 2 and 3 and Example 2.

Referring to FIGS. 11A and 11B, the coexistence of the binding structures for Comparative Examples 2 and 3 in the analysis results of Example 2 can be confirmed through the Ni 2p and Fe 2p values.

In addition, the XPS analysis results enable to confirm that the binding energy of Li5FeO4 exists in the region of 710.78 (Fe³⁺) and 724.08 eV (Fe³⁺) for Fe 2p.

### Experimental Example 5: Analysis Results of Electrical Conductivity Characteristics of Comparative Examples and Examples

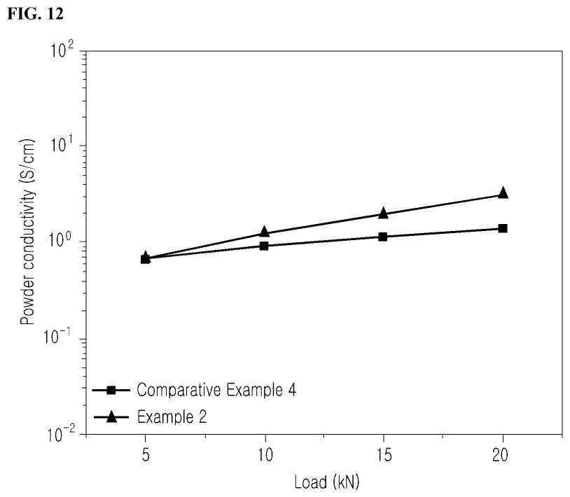

Referring to FIGS. 12 to 14, the electrical conductivity characteristics of Comparative Examples and examples are described.

FIG. 12 shows the results of analysis for powder conductivity measurement according to pressure for Comparative Example 4 and Example 2.

Referring to FIG. 12, it can be confirmed that Example 2 exhibits high conductivity at each load value due to the formation of a uniform coating layer of lithium active material compared to Comparative Example 4.

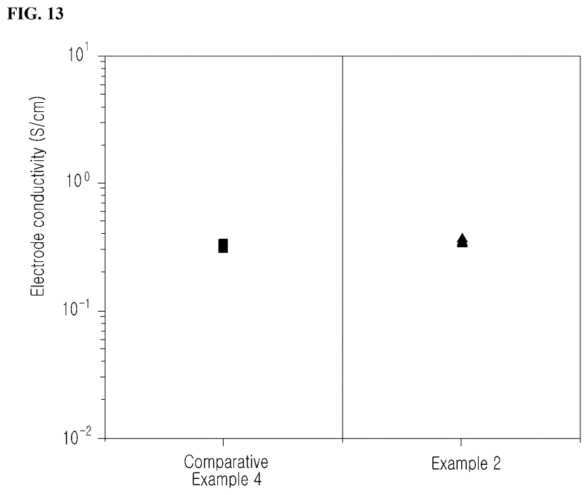

FIG. 13 shows the results of analysis for electrical conductivity measurement for Comparative Example 4 and Example 2.

Referring to FIG. 13, it can be confirmed that Example 2 exhibits higher electrical conductivity than Comparative Example 4 due to the formation of a uniform coating layer of lithium active material and improved compatibility of electrode units.

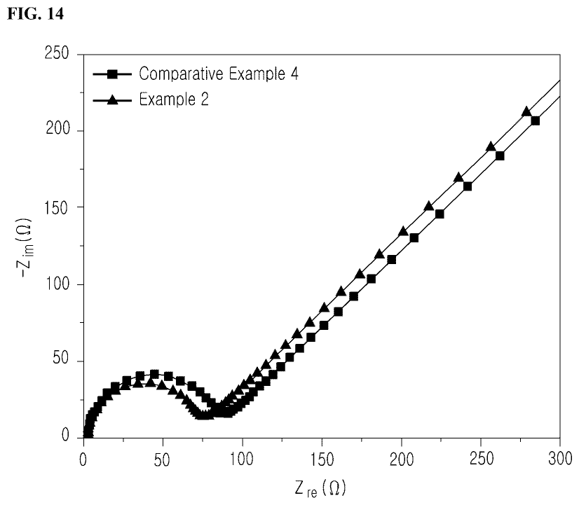

FIG. 14 shows the results of impedance analysis for Comparative Example 4 and Example 2.

Referring to FIG. 14, it can be confirmed that Example 2 exhibits lower resistance than Comparative Example 4 due to the formation of a uniform coating layer of lithium active material and improved compatibility of electrode units.

### Experimental Example 6: Results of Electrochemical Characteristic Analysis of Comparative Examples and Examples

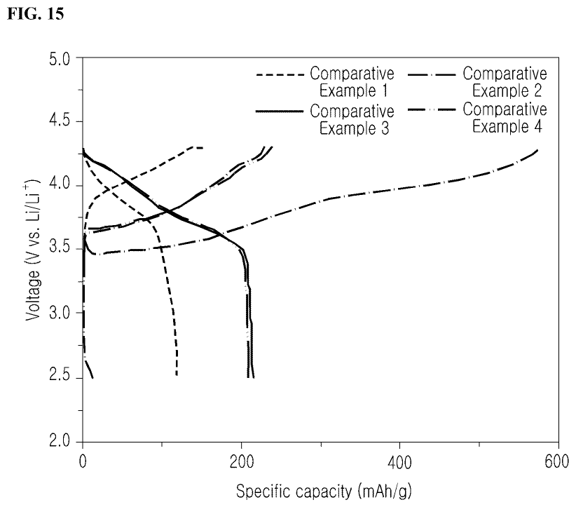

Referring to FIGS. 15 to 22, the electrochemical characteristics of Comparative Examples and examples will be described.

FIG. 15 shows the results of electrochemical characteristic evaluation for Comparative Examples 1, 2, 3, and 4.

Referring to FIG. 15, the electrochemical charging capacity for Comparative Example 1 was confirmed to be 155.5 mAh/g and the charge/discharge efficiency was 76.7%, the electrochemical charging capacity for Comparative Example 2 was confirmed to be 576.7 mAh/g and the charge/discharge efficiency was 2.2%, and the electrochemical charging capacity for Comparative Example 3 was confirmed to be 229.7 mAh/g and the charge/discharge efficiency was 92.9%. In addition, the electrochemical charging capacity for Comparative Example 4 was confirmed to be 238.9 mAh/g, and the charge/discharge efficiency was 87.4%.

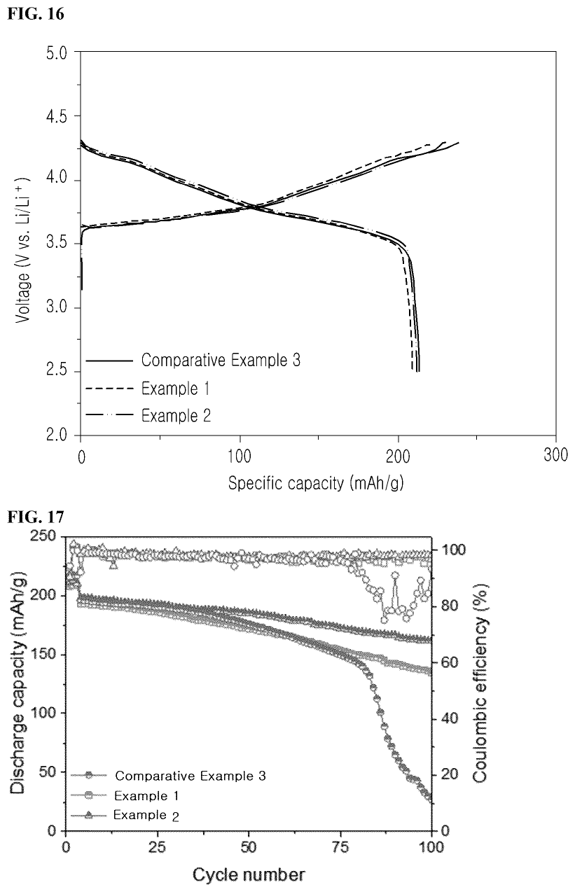

FIG. 16 shows the results of electrochemical characteristic evaluation for Comparative Example 3 and Examples 1 and 2.

Referring to FIG. 16, it can be confirmed that the charge/discharge efficiency of Example 1 increased to 94.3% compared to 92.9% of Comparative Example 3, while it decreased to 89.2% for Example 2, and the initial charge capacity of Example 1 was confirmed to be about 96.6% compared to Comparative Example 3, and about 103.7% for Example 2.

Through FIGS. 15 to 16, it can be confirmed that the composite material for a cathode active material according to an example of the disclosure has excellent electrochemical charging capacity.

FIG. 17 shows the results of the life characteristic evaluation for Comparative Example 3 and Examples 1 and 2.

Referring to FIG. 17, in the case of Examples 1 and 2 compared to Comparative Example 3, the surface stabilization of the NCM-based cathode active material may be induced due to the formation of a functional rock-salt coating layer, and it can be confirmed that the capacity retention rate tends to increase after the 100th charge/discharge.

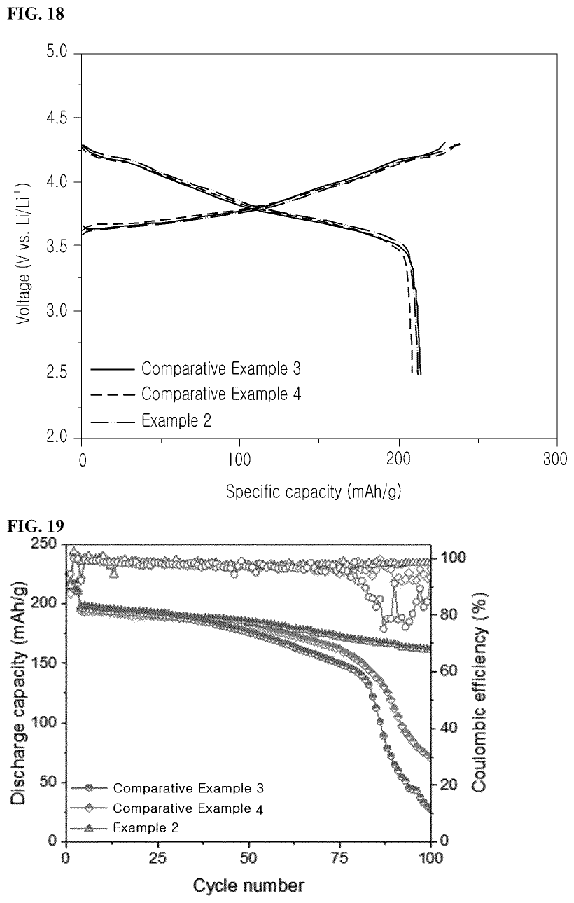

FIG. 18 shows the results of the electrochemical characteristic evaluation for Comparative Example 3 and Examples 2 and Comparative Example 4.

Referring to FIG. 18, the charge/discharge efficiency of Comparative Example 3 increased to 87.4% compared to 92.9% in Example 4, while it decreased to 89.2% in the case of Example 2.

In addition, an initial charge capacity of about 103.7% for Example 2 compared to Comparative Example 3 and about 104.0% for Comparative Example 4 can be confirmed.

FIG. 19 shows the results of the life characteristic evaluation for Comparative Example 3 and Examples 2 and Comparative Example 4.

Referring to FIG. 19, it can be confirmed that the life characteristics of Example 2 compared to Comparative Example 4 are improved due to the improvement of the electrode unit compatibility of the lithium active material due to the coating of the lithium active material and the stabilization of the surface of the NCM cathode active material, and it can be confirmed that the capacity retention rate tends to improve after the 100th charge/discharge.

FIG. 20 shows the results of the high-temperature electrochemical characteristic evaluation for Comparative Example 3 and Examples 1 and 2.

Referring to FIG. 20, it can be confirmed that the charge/discharge efficiency of Example 1 increased to 96.7% compared to 94.7% of Comparative Example 3, while it decreased to 91.5% for Example 2.

In addition, it can be confirmed that the initial charge capacity of Example 1 is about 97.7% compared to Comparative Example 3, and that of Example 2 is about 100.1%.

As such, it can be confirmed that the cathode active material composite material according to an example of the disclosure exhibits excellent initial charge capacity.

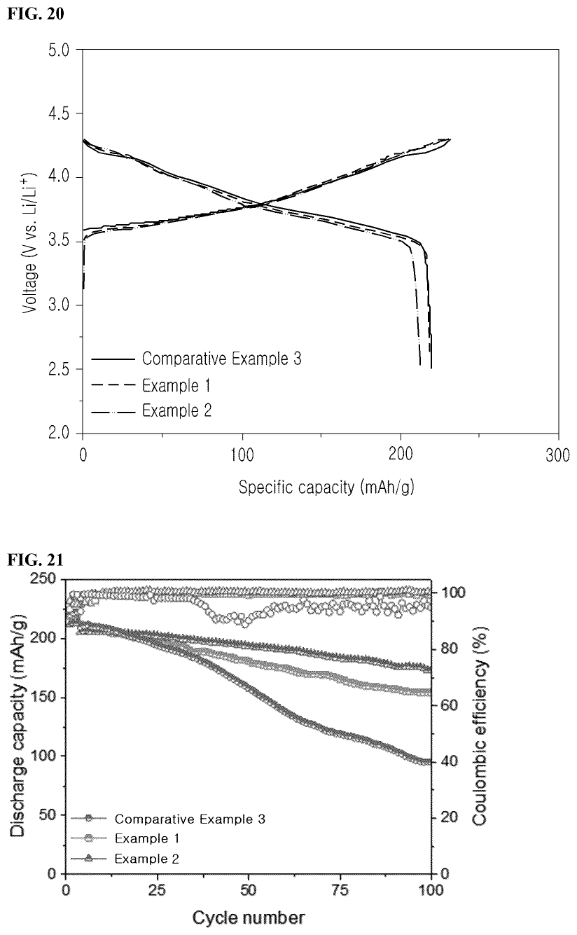

FIG. 21 shows the results of the high-temperature life characteristic evaluation for Comparative Example 3 and Examples 1 and 2.

Referring to FIG. 21, it can be confirmed that the capacity retention rate after the 100th charge/discharge of Comparative Example 3 increased to 72.6% for Example 1 and 82.9% for Example 2.

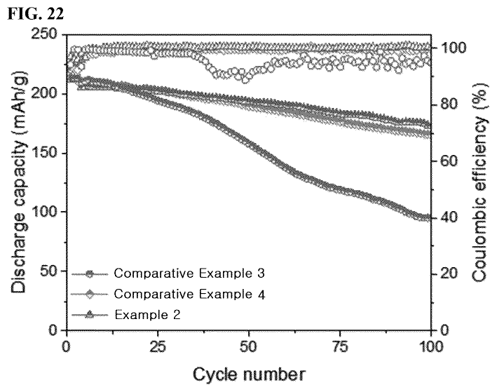

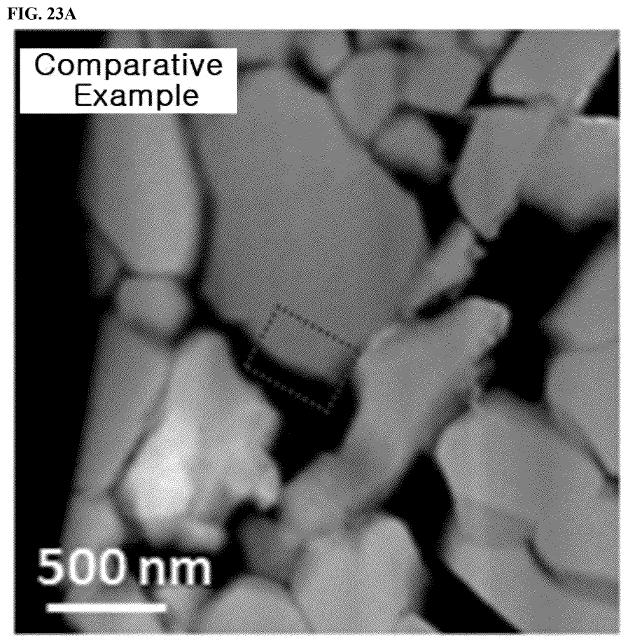

FIG. 22 shows the results of the high-temperature life characteristic evaluation for Comparative Example 3 and Examples 2 and Comparative Example 4.

Referring to FIG. 22, it can be confirmed that the life characteristic of Example 2 is improved compared to Comparative Example 4 due to the improved electrode unit compatibility of the lithium active material due to the coating of the lithium active material and the surface stabilization of the NCM cathode active material, and it can be confirmed that the capacity retention rate after the 100th charge/discharge tends to increase.

### Experimental Example 7: TEM and EDS Analysis Results of Comparative Examples and Examples

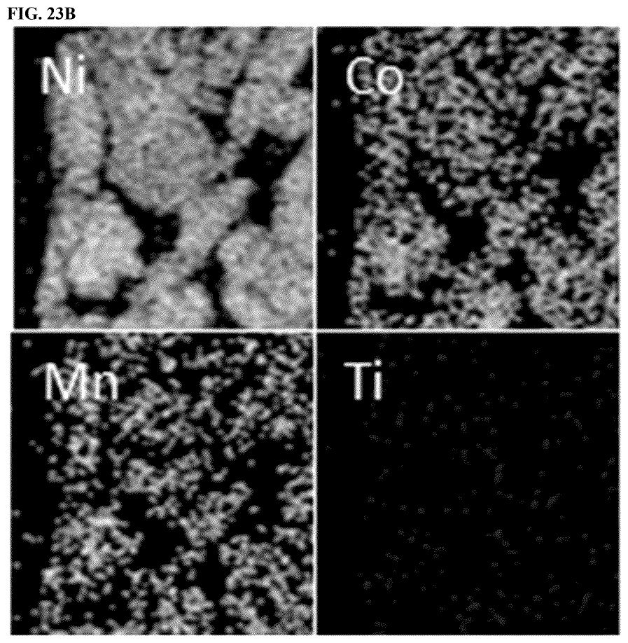

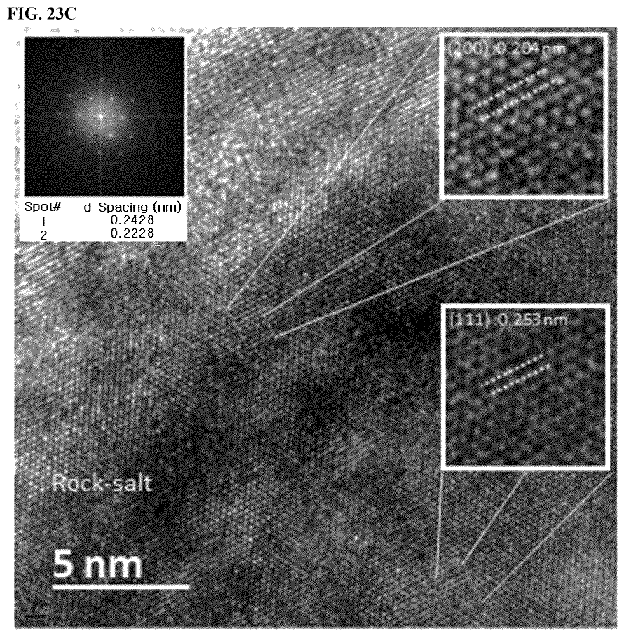

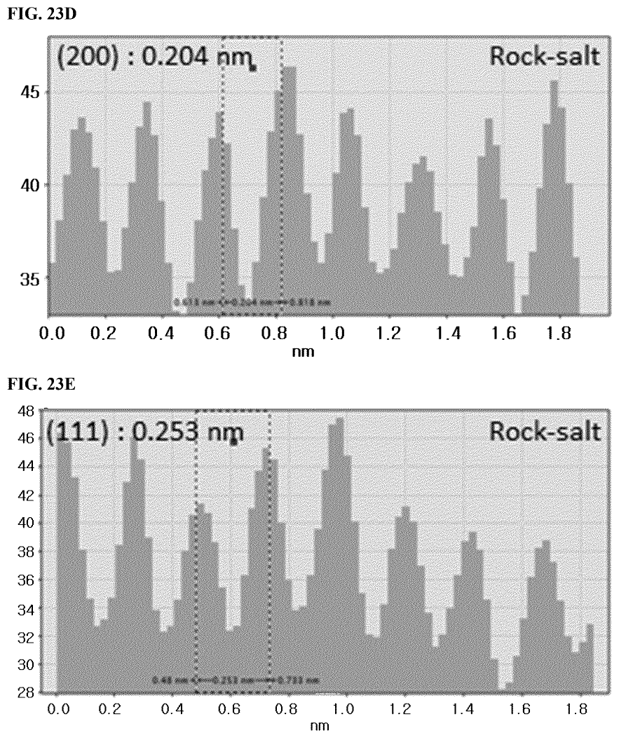

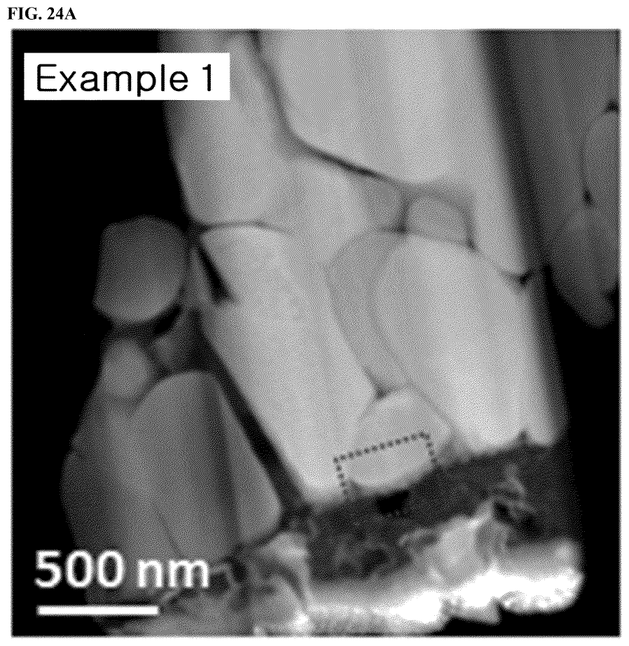

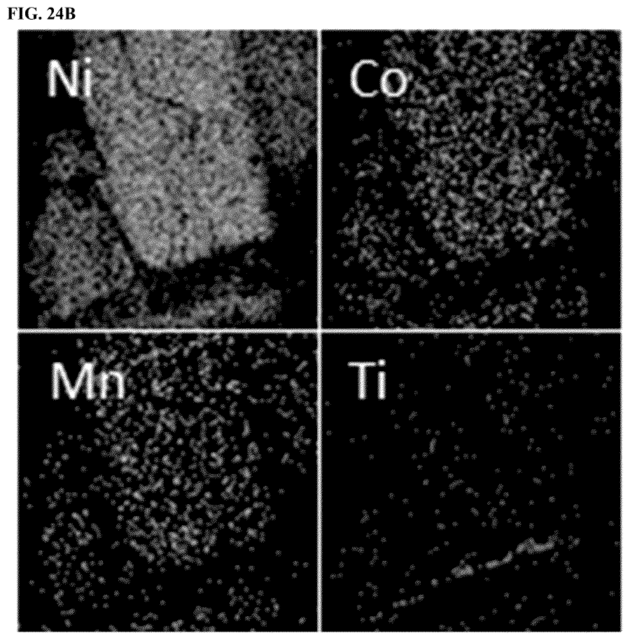

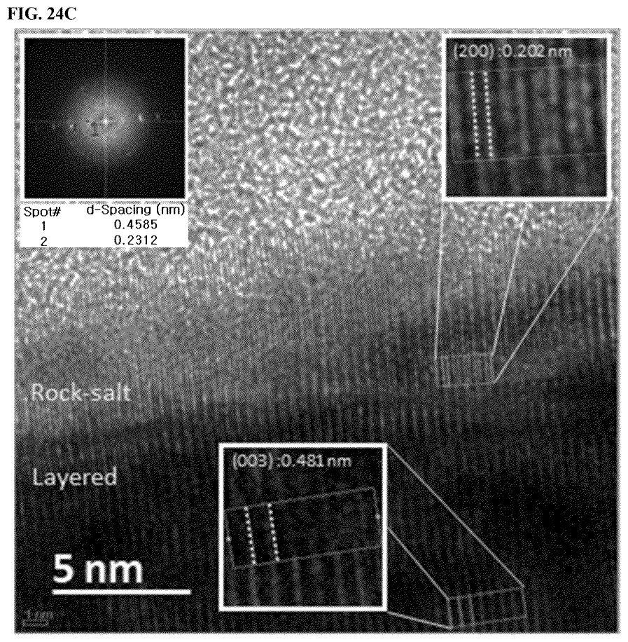

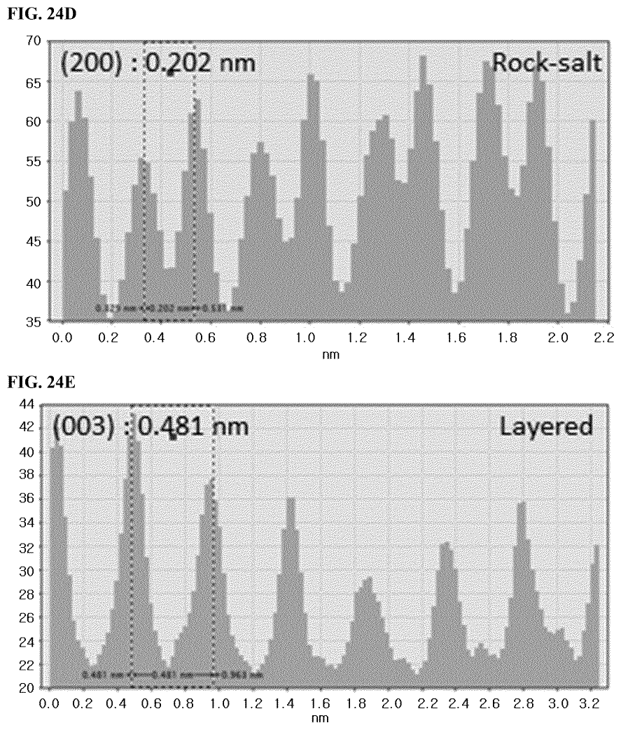

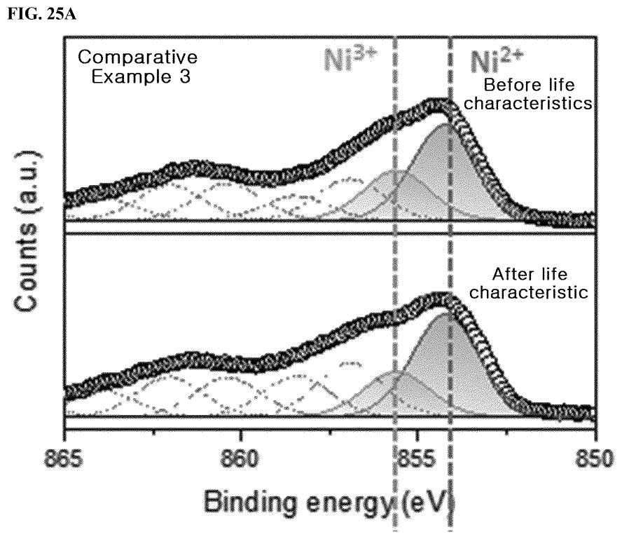

Referring to FIGS. 23 and 24A, 24B, 24C, 24D, and 24E, the interplanar distance and surface characteristics of Comparative Examples and examples will be described.

FIGS. 23A, 23B, 23C, 23D, and 23E show the results of measuring TEM images after the life characteristics of Comparative Example 3 and the results of measuring element distribution through EDS analysis.

Referring to FIGS. 23A, 23B, 23C, 23D, and 23E, the interplanar distance (0.204 & 0.253 nm) for rock-salt was confirmed in the analysis results of Comparative Example 3, and through this, it can be confirmed that the rock-salt phase transition occurred in a layered manner not only on the surface but also on the inside.

FIGS. 24A, 24B, 24C, 24D, and 24E show the results of measuring TEM images after the life characteristics of Example 1 and the results of measuring element distribution through EDS analysis.

Referring to FIGS. 24A, 24B, 24C, 24D, and 24E, the analysis results of Example 1 enable to confirm the interplanar distance (0.202 nm) for Comparative Example 1, and it was confirmed that the internal interplanar distance (0.481 nm) for Comparative Example 3 was maintained. Through this, it can be confirmed that the LMM′O lithium active layer improved the surface stability.

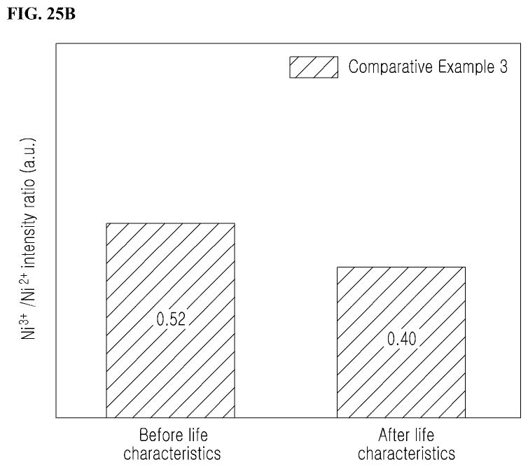

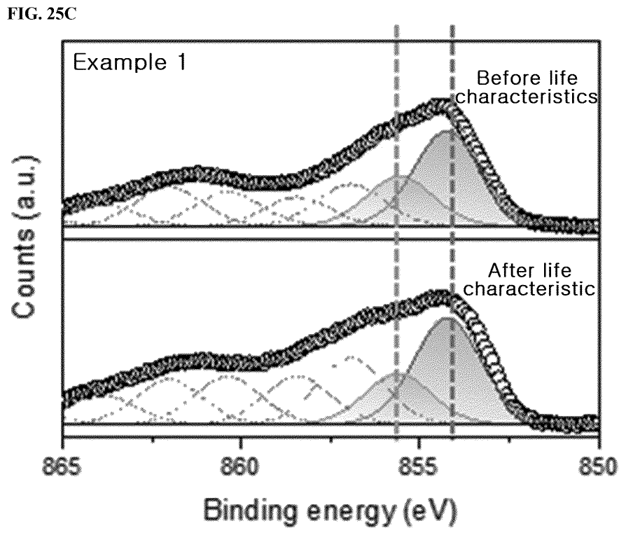

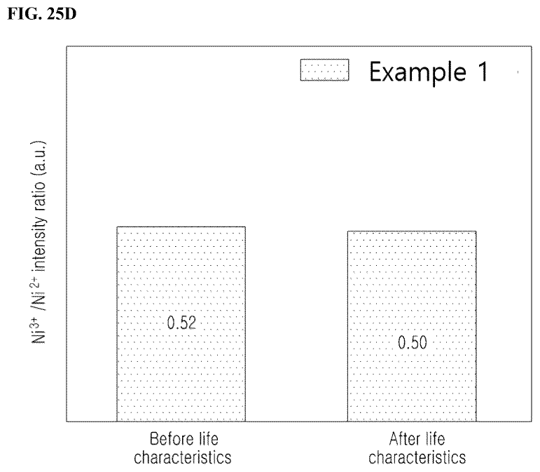

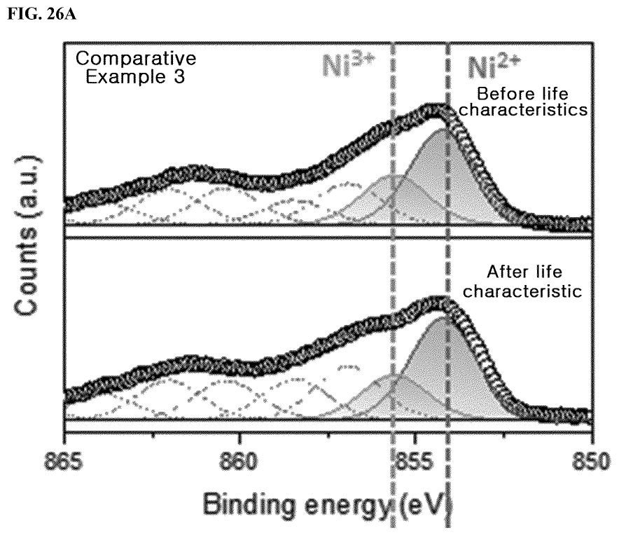

FIGS. 25A, 25B, 25C, and 25D show the results of measuring XPS inside the particles after the life characteristics of Comparative Example 3 and Example 1.

Referring to FIGS. 25A, 25B, 25C, and 25D, it can be confirmed that the Ni³⁺/Ni²⁺ ratio was improved in the internal particle of Example 1 compared to Comparative Example 3 in the analysis results.

Through this, it can be seen that the LMM′O lithium active layer has the effect of suppressing the rock-salt phase transition inside the NCM.

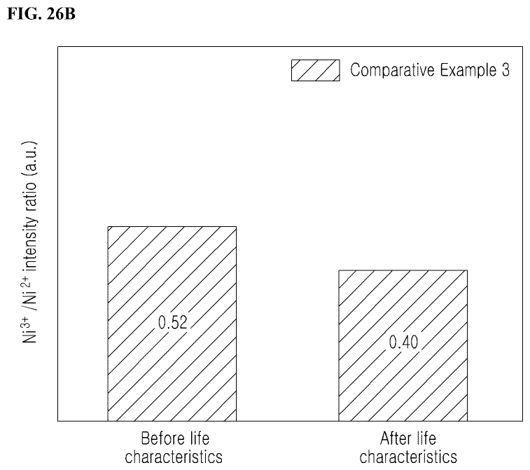

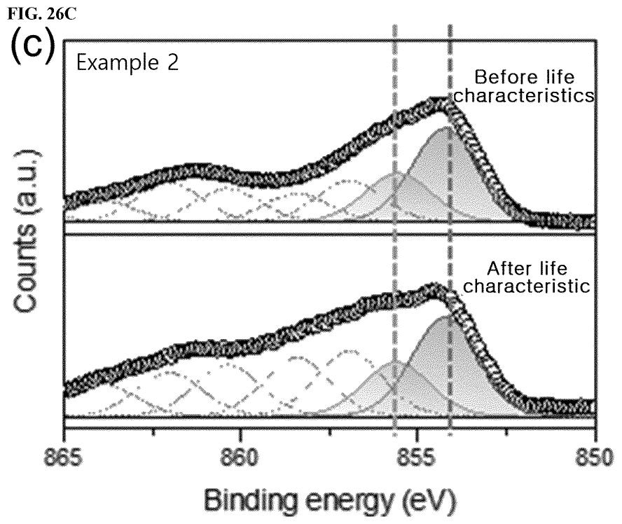

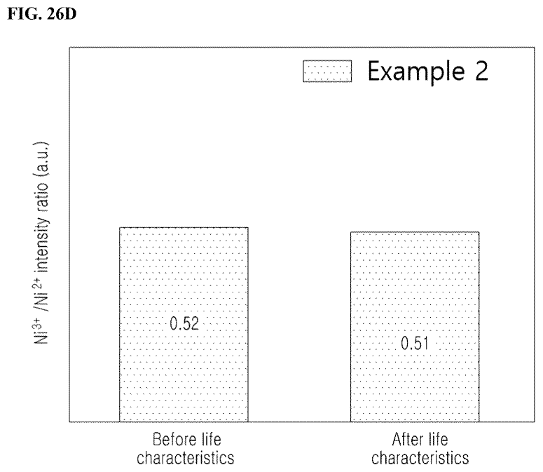

FIG. 26 shows the results of measuring XPS inside the particles after the life characteristics of Comparative Example 3 and Example 2.

Referring to FIG. 26, it can be confirmed that the Ni³⁺/Ni²⁺ ratio is improved in the particles of Example 2 compared to Comparative Example 3.

Through this, it can be confirmed that the LMM′O lithium active layer has the effect of suppressing the rock-salt phase transition inside the NCM.

The description of the disclosure described above is for illustrative purposes, and those skilled in the art will understand that the disclosure is easily modifiable into other specific forms without changing the technical idea or essential features of the disclosure. Therefore, the examples described above should be understood in all respects as illustrative and not restrictive. For example, each component described as single may be implemented in a distributed manner, and similarly, components described as distributed may also be implemented in a combined form.

The scope of the disclosure is indicated by the claims described below, and all changes or modified forms derived from the meaning and scope of the claims and their equivalent concepts should be construed as being included in the scope of the disclosure.

What is claimed is:

1. A composite material for a cathode active material, characterized by comprising:
an NCM-based cathode active material; and
a positive electrode coating layer coated on the surface of the NCM-based cathode active material and composed of a positive electrode coating material represented by Chemical Formula 1: 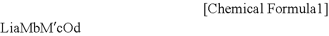
wherein in Chemical Formula 1, M is at least one of a metal element forming a divalent cation or a trivalent cation,
M′ is at least one of a metal element forming a tetravalent cation, 2≤a≤14, 1≤b≤2, 0≤c≤1, and 4≤d≤9.

2. The composite material for a cathode active material of claim 1, wherein in Chemical Formula 1, M is at least one selected from the group consisting of Ni, Co, Mn and Fe, and M′ is at least one selected from the group consisting of Ti, V, Nb and Ta.

3. The composite material for a cathode active material of claim 1, wherein the NCM-based cathode active material is represented by Chemical Formula 2: 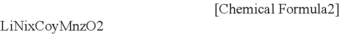
in Chemical Formula 2, 0.5≤x<1.0, 0.0≤y<0.5, 0.0≤z<0.5, and x+y+z=1.

4. The composite material for a cathode active material of claim 1, wherein the positive electrode coating material is coated in an amount of 0.1 to 5 wt % relative to the cathode active material.

5. The composite material for a cathode active material of claim 1, wherein the positive electrode coating material forms a rock-salt crystal structure.

6. The composite material for a cathode active material of claim 5, wherein the positive electrode coating material forming the rock-salt crystal structure is composed of Li2NiTiO4, Li2CoTiO4 or Li2MnTiO4.

7. A composite material for a cathode active material, characterized by comprising: an NCM-based cathode active material; and a positive electrode coating layer coated on the surface of the NCM-based cathode active material and composed of a positive electrode coating material represented by Chemical Formula 3: 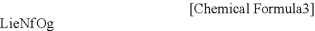
in Chemical Formula 3, N is at least one metal element from groups 3 to 12 and periods 4 to 7, 1≤e≤14, 1≤f≤5, and 2≤g≤9.

8. The composite material for a cathode active material of claim 7, wherein in Chemical Formula 3, N is at least one selected from the group consisting of Fe, Ni, Co, and Mn.

9. The composite material for a cathode active material of claim 7, wherein the NCM-based cathode active material is represented by Chemical Formula 2: 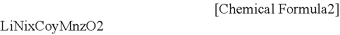
in Chemical Formula 2, 0.5≤x<1.0, 0.0≤y<0.5, 0.0≤z<0.5, and x+y+z=1.

10. The composite material for a cathode active material of claim 7, wherein the positive electrode coating material is coated in an amount of 0.1 to 5 wt % relative to the cathode active material.

11. A method for manufacturing a composite material for a cathode active material, characterized by comprising:
preparing an NCM-based cathode active material and a positive electrode coating material represented by Chemical Formula 1 or Chemical Formula 3; and
manufacturing a composite material for a cathode active material by mixing the NCM-based cathode active material and a composite material for a cathode active material and heat-treating the same to coat the positive electrode coating material on the surface of the NCM-based cathode active material to form a positive electrode coating layer: 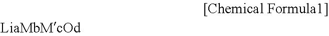
wherein in Chemical Formula 1, M is at least one of a metal element forming a divalent cation or a trivalent cation,
M′ is at least one of a metal element forming a tetravalent cation, 2≤a≤14, 1≤b≤2, 0≤c≤1, and 4≤d≤9. 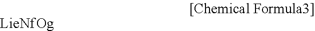
in Chemical Formula 3, N is at least one metal element from groups 3 to 12 and periods 4 to 7, 1≤e≤14, 1≤f≤5, and 2≤g≤9.

12. The method of claim 11, wherein in the manufacturing of the composite material for the cathode active material, the heat treatment is performed in an oxygen atmosphere at a temperature range of 300C to 900C.

13. The method of claim 11, wherein when a secondary battery containing the composite material for a cathode active material is charged, the positive electrode coating layer changes into a rock-salt crystal structure.

14. A lithium secondary battery, characterized by comprising the composite material for a cathode active material of claim 1.
